(19) United States
(12) Patent Application Publication
(10) Pub. No.: US 2026/0019293 A1
(43) Pub. Date: Jan. 15, 2026

(54) REGION CONFIGURATION METHOD, TARGET DETECTION METHOD AND DEVICE

(71) Applicant: LUMI UNITED TECHNOLOGY CO., LTD., Shenzhen (CN)

(72) Inventors: Zhaoze ZENG, Shenzhen (CN); Qianxu WU, Shenzhen (CN); Yujing MENG, Shenzhen (CN)

(73) Assignee: LUMI UNITED TECHNOLOGY CO., LTD., Shenzhen (CN)

(21) Appl. No.: 19/333,412

(22) Filed: Sep. 19, 2025

Related U.S. Application Data
(63) Continuation-in-part of application No. PCT/CN2024/082540, filed on Mar. 19, 2024.
(63) Continuation-in-part of application No. PCT/CN2024/082564, filed on Mar. 20, 2024.
(63) Continuation-in-part of application No. PCT/CN2024/085099, filed on Mar. 30, 2024.

(30) Foreign Application Priority Data
Mar. 20, 2023 (CN) 202310280107.5
Mar. 20, 2023 (CN) 202310304730.X
Mar. 30, 2023 (CN) 202310353120.9

(51) Int. Cl. H04L 12/28; H04L 41/08; H04L 41/22

(52) U.S. Cl. CPC H04L 12/2807; H04L 12/282; H04L 41/0883; H04L 41/22

(57) ABSTRACT

The present disclosure relates to a region configuration method, a target detection method, and a device, includes: displaying a region management page; the region management page comprising a spatial region corresponding to a target space; obtaining a user selection of an arbitrary area within the spatial region, and generating a custom region; in response to a selection operation directed to the custom region, displaying a function configuration page for the custom region; obtaining a function item selected on the function configuration page, and displaying, on the function configuration page, configured attribute information adapted to the function item for the custom region; wherein the attribute information is configured for target detection within each custom region.

The present disclosure is a Continuation In Part of International Patent Application No. PCT/CN2024/082540 filed on 19 Mar. 2024, International Patent Application No. PCT/CN2024/082564 filed on 20 Mar. 2024, and International Patent Application No. PCT/CN2024/085099 filed on 30 Mar. 2024, each of which claims priority to Chinese Patent Application No. CN202310280107.5 filed on 20 Mar. 2023, Chinese Patent Application No. CN202310304730.X filed on 20 Mar. 2023, and Chinese Patent Application No. CN202310353120.9 filed on 30 Mar. 2023. The entire contents of the aforementioned applications are incorporated herein by reference.

### TECHNICAL FIELD

The present disclosure relates to the technical field of the Internet of Things, more specifically, the present disclosure relates to a region configuration method, a target detection method, and a device.

### BACKGROUND

With the development of Internet of Things (IoT) technologies, intelligent control of devices has found ever wider disclosure in daily life. Taking smart homes as an example, a smart home connects various household devices, such as audio video equipment, lighting systems, curtain controls, air conditioning controls, security systems, digital cinema systems, media servers, movie cabinet systems, and network appliances, through IoT technology, and offers a variety of functions and means: appliance control, lighting control, telephone remote control, indoor/outdoor remote control, burglar alarms, environmental monitoring, HVAC control, infrared forwarding, and programmable timer control, among others.

At present, devices in target spaces (e.g., different rooms of a home) are usually configured uniformly. Consequently, existing region configuration methods lack flexibility, which easily leads to low accuracy in target detection.

### SUMMARY OF THE DISCLOSURE

The present disclosure provides a region configuration method, a target detection method and a device that may improve the flexibility of spatial configuration and thereby increase the accuracy of target detection.

In one aspect, a region configuration method performed by a computer device includes: displaying a region management page; the region management page including a spatial region corresponding to a target space; obtaining a user selection of an arbitrary area within the spatial region, and generating a custom region; in response to a selection operation directed to the custom region, displaying a function configuration page for the custom region; obtaining a function item selected on the function configuration page, and displaying, on the function configuration page, configured attribute information adapted to the function item for the custom region; wherein the attribute information is configured for target detection within each custom region.

In another aspect, a target detection method includes: obtaining target signals of a target object for each target monitoring region in a current space; performing feature extraction on the target signals to obtain target features corresponding to the target object in each target monitoring region; determining a target detection result corresponding to each target monitoring region, based on attribute information corresponding to each target monitoring region and the target features; wherein the attribute information is obtained by configuring a user selection of an arbitrary area within a spatial region of a region management page, to generate target monitoring regions, and for each target monitoring region, configuring attribute information adapted to function items within each target monitoring region.

A computer device is also provided, including a memory and a processor, wherein the memory stores instructions which, when executed by the processor, cause the processor to carry out the method described in any embodiment of the present disclosure.

A computer readable storage medium is provided, having stored thereon a computer program that, when executed by a processor, performs the steps of the region configuration method and/or the target detection method described in any embodiment of the present disclosure.

A computer program product or computer program is provided, the computer program product or computer program including computer instructions stored in a computer readable storage medium; the processor of the computer device reads the computer instructions from the computer readable storage medium, and when executing the computer instructions, performs the steps of the region configuration method and/or the target detection method described in any embodiment of the present disclosure.

### BRIEF DESCRIPTION OF THE DRAWINGS

To illustrate the technical solutions of the present disclosure more clearly, a brief description is given below of the drawings that are required in the description of embodiments of the disclosure. It will be evident that the drawings described are merely some embodiments of the disclosure, and that a person skilled in the art may obtain other drawings without creative effort.

FIG. 1 is an disclosure environment diagram of a region configuration method in an embodiment.

FIG. 2 is a flow chart schematic of a region configuration method in an embodiment.

FIG. 3a is an interface schematic of an electronic device in an embodiment.

FIG. 3b is an interface schematic of an electronic device in another embodiment.

FIG. 4 is a schematic of point cloud features of a human body in an embodiment.

FIG. 5 is a mapping relationship diagram of a region configuration method in an embodiment.

FIG. 6 is a scene schematic of the region configuration method provided by an embodiment of the disclosure.

FIG. 7 is another scene schematic of the region configuration method provided by an embodiment of the disclosure.

FIG. 8 is a schematic of an attribute information selection process in a region configuration method in an embodiment.

FIG. 9 is a schematic of a configuration page in a region configuration method in an embodiment.

FIG. 10 is a schematic of delimiting a custom region in a region configuration method in an embodiment.

FIG. 11 is a schematic of a color selection page in a region configuration method in an embodiment.

FIG. 12 is a schematic of a region attribute selection page in a region configuration method in an embodiment.

FIG. 13 is a schematic of a region monitoring selection page in a region configuration method in an embodiment.

FIG. 14 is a schematic of a trigger condition page in a region configuration method in an embodiment.

FIG. 15 is a schematic of a region option page in a region configuration method in an embodiment.

FIG. 16 is a schematic of a condition page in a region configuration method in an embodiment.

FIG. 17 is a schematic of a room layout in a region configuration method in an embodiment.

FIG. 18 is a flow chart schematic of a region configuration method in another embodiment.

FIG. 19 is a flow chart schematic of a region configuration method in yet another embodiment.

FIG. 20 is a detailed schematic of cluster analysis in the target detection method provided by an embodiment of the disclosure.

FIG. 21 is an internal structure diagram of a computer device in an embodiment.

### DETAILED DESCRIPTION

To set forth the objects, technical solutions and advantages of the present disclosure more clearly, the following further describes the disclosure in detail with reference to the accompanying drawings and embodiments. It should be understood that the specific embodiments described herein are merely used to explain the present disclosure and are not intended to limit the present disclosure.

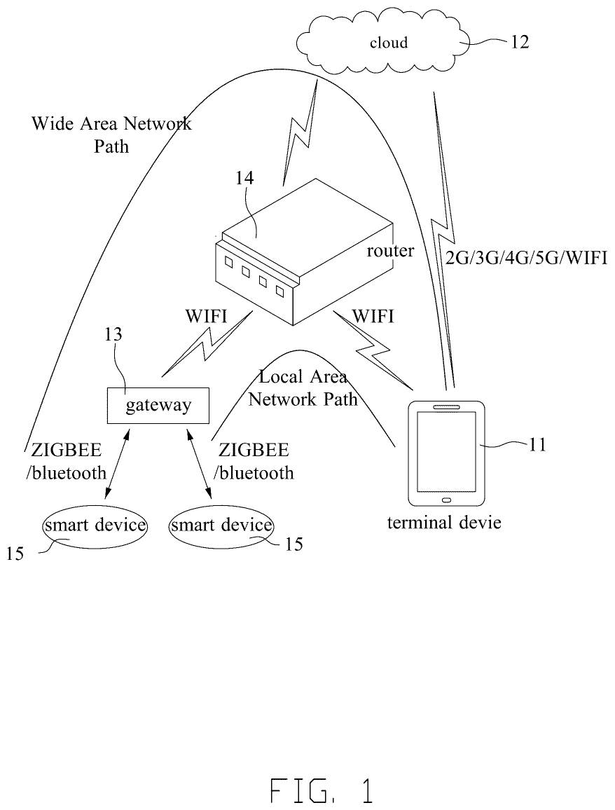

FIG. 1 is an disclosure environment diagram of a region configuration method in an embodiment. Referring to FIG. 1, the region configuration method provided by an embodiment of the present disclosure may be applied to an IoT system shown in FIG. 1. The IoT system includes a terminal device 11, a cloud 12, a gateway device 13, a router 14 and a smart device 15. Specifically, the terminal device 11 may be any smart device having communication and storage functions, for example, a smart phone, a smart control panel, a desktop computer, a laptop computer, a tablet computer or other smart communication device having network connection function. The cloud 12 may be a network access server, a database server, a cloud server, etc. Optionally, the gateway device 13 may be built based on the ZigBee protocol, and the smart device 15 may be controlled by the terminal device 11 or the cloud 12 and may be pre joined to the gateway device 13. For example, the smart device 15 may be a device in a kit to which the gateway device 13 belongs when the gateway device 13 leaves the factory, or may be a device subsequently connected to the gateway device 13 through user operation.

Optionally, a client capable of managing the smart device 15 is installed in the terminal device 11. The client may be an application client (such as an APP of a mobile phone) or a web client, which is not limited herein.

Optionally, the terminal device 11 and the smart device 15 may both access an Ethernet through the gateway device 13, and the gateway device 13 may access the cloud 12 through a wired or wireless communication connection. For example, the gateway device 13 and the terminal device 11 may store acquired information in the cloud 12. Optionally, the terminal device 11 may also establish a network connection with the cloud 12 through 2G/3G/4G/5G, WiFi, etc., so as to acquire data issued by the cloud 12.

Optionally, the terminal device 11, the gateway device 13 and the smart device 15 may be in the same local area network, or may be in the same wide area network as the cloud 12. When the terminal device 11 and the gateway device 13 are in the same local area network, the terminal device 11 may interact with the gateway device 13 and the smart device 15 connected to the gateway device 13 through a local area network path, or may also interact with the gateway device 13 and the smart device 15 connected to the gateway device 13 through a wide area network path. When the terminal device 11 and the gateway device 13 are not in the same local area network, the terminal device 11 may interact with the gateway device 13 and the smart device 15 connected to the gateway device 13 through a wide area network path. The smart device 15 may include, but is not limited to, smart lamps, automatic curtains, air conditioners, smart door locks, smart cameras, smart air conditioners, smart TVs, smart control panels and other smart home products.

The terminal device 11 may acquire information of a region management page and send the information to the cloud 12. The cloud 12 receives the information, forms a region management page according to the information and sends the region management page to the terminal device 11; then the terminal device 11 generates a custom region based on a region selected by a user on the region management page, and completes configuration of the custom region according to a selection operation of the user. The smart device 15 detects an actual space, collects or acquires human position information or object movement information in the actual space (which is not specifically limited in this embodiment), and then performs a corresponding control operation according to configuration of the custom region, so as to achieve smart control.

In another embodiment, after the terminal device 11 acquires the information of the region management page, the terminal device 11 displays the region management page, and generates a custom region based on a selected region of the region management page; then the terminal device 11 completes configuration of the custom region according to an obtained selection operation. Afterwards, the terminal device 11 transmits a configuration result to the cloud 12. The cloud 12 performs automatic control on smart furniture based on the configuration result and detection information uploaded by the smart device.

That is, the present disclosure does not specifically limit a current execution device that executes the present configuration method, and the current execution device may be a terminal such as a smart phone, a computer, a smart furniture controller, etc., or may be a server end composed of an independent server or a cluster server.

Automation refers to a linkage application built between the gateway device 13 or devices connected to the gateway device 13; the automation includes a trigger condition and an execution action, and devices that implement automatic scene control include a trigger device and a controlled device (or an execution device), and the two may communicate with each other through the gateway device 13. When the trigger device satisfies the trigger condition, the gateway device 13 controls the controlled device to perform a corresponding execution action. The trigger device may be various sensors such as radar sensors, pressure sensors, etc. The controlled device may be various switches, TVs, sockets, lamps and other smart devices 15.

Assume that the IoT system is provided with an automatic scene control: automatically turning on a light when a human body is detected in a target environment. A condition of this scene is that a human body is detected in the target environment, and an execution action is that a smart switch controls a bulb to turn on. Based on this application scenario, a radar sensor may be set as a trigger device, and a smart switch connected to a lamp may be set as a controlled device. A specific execution principle is: if automation is executed locally at the gateway through a local area network path, after the gateway receives an event that a human body is detected, the gateway finds a device that performs an action according to stored automatic configuration information. In this embodiment, the device that performs the action may be a smart switch, and the gateway notifies the smart switch to turn on the light, thereby implementing the automatic linkage of automatically turning on the light when a human body is detected in the target environment. If automation is executed in the cloud through a wide area network path, after the gateway receives the event that a human body is detected, the gateway reports the event to the cloud, and the cloud finds a device that performs an action according to stored scene configuration information. In this embodiment, the device that performs the action may be a smart switch, and the cloud notifies the smart switch to turn on the light through the gateway.

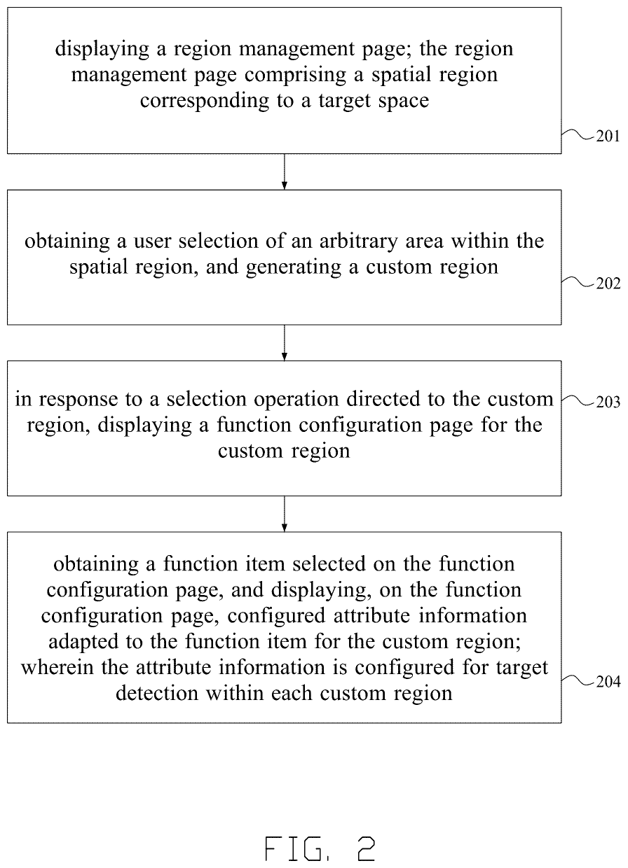

In an embodiment, as shown in FIG. 2, a region configuration method is provided. This embodiment illustrates the method by taking an example that the method is applied to a computer device. It may be understood that the computer device may be a terminal device or a smart device having a display function. The method may also be applied to a system including at least two of a smart device, a terminal device and a server, and is implemented through interaction of at least two of the terminal device, the smart device, the gateway device and the server. In this embodiment, the method includes the following steps:
Step S201: displaying a region management page; the region management page comprising a spatial region corresponding to a target space.

The region management page is a page configured to display a spatial region corresponding to a target space, and may be configured for a user to configure the spatial region. In an embodiment, the region management page may include a configuration page, and the configuration page may refer to a page capable of displaying parameters to be set for smart furniture monitoring.

Specifically, in an embodiment, the configuration page may include displaying a region to be configured by using a two dimensional picture, that is, the displayed region to be configured is a two dimensional picture. Specifically, a computer device may display through a web page or may display in software, which is not specifically limited in this embodiment.

In another embodiment, the configuration page may further include displaying a region to be configured by using a three dimensional space, that is, the displayed region to be configured is a three dimensional solid model having x, y and z axes, which is not specifically limited in this embodiment.

The target space is a space that currently needs spatial configuration. In an embodiment, a target space may be, but is not limited to, a household, a floor, a building and other household spaces or office spaces.

A spatial region is a region corresponding to a target space, and may specifically be a designated space that is pre divided, or a region, in the target space, corresponding to a monitoring range of a sensing device. In an embodiment, a spatial region displayed in a configuration page may include only a page region configured for a user to configure a monitoring region, or may further include a page region that is not configured for the user to configure a monitoring region, for example, a reference page region through which the user may configure a monitoring region by using a computer device, or an operation page region configured for the user to configure a monitoring region. In an embodiment, specifically, for example, when a target space is a household, a spatial region may be a living room in the household or a region in the living room, and when a target space is a floor, a spatial region may be a household on the floor or a living room on the floor. A region management page may display an entire room including a living room, a bedroom, a kitchen, etc., or a space that is not distinguished by use; or may be a local region in a room, for example, a living room, a bathroom or a partial region of a living room, which is not specifically limited in this embodiment.

In an embodiment, positions of spatial regions under a target space may be obtained through a position configuration step. In an embodiment, the position configuration step includes: performing division of a spatial region of a target space by using a technology of locating and tracking a target object such as a human body. Performing division of a spatial region of a target space by using a technology of locating and tracking a target object includes: obtaining a plurality of target signals under the target space; obtaining a distance, a speed and an angle of the target object according to the plurality of target signals; and performing division of the spatial region of the target space according to the distance, the speed and the angle of the target object.

Specifically, the plurality of target signals may be echo signals received after a millimeter wave radar device transmits a Frequency Modulated Continuous Wave (FMCW) signal. A computer device may obtain a distance between the target object and the millimeter wave radar device by performing a Fast Fourier Transform (FFT) operation on the echo signals. A point cloud speed of the target object may be obtained by comparing two echo signals. The computer device may obtain an angle of the target object relative to the millimeter wave radar device according to a phase difference of a plurality of echo signals. Locating and tracking of the target object may be implemented according to the distance, the speed and the angle of the target object, and then division of the spatial region of the target space may be performed.

In an embodiment, a region management page may include a page region that displays a range of a corresponding spatial region, or may further include a page region that displays a sub spatial region of the corresponding spatial region, or a page region of a device of the corresponding spatial region. To facilitate a user to operate the region management page, the displayed corresponding spatial region may include a page region of an equal scale plan view of the corresponding spatial region.

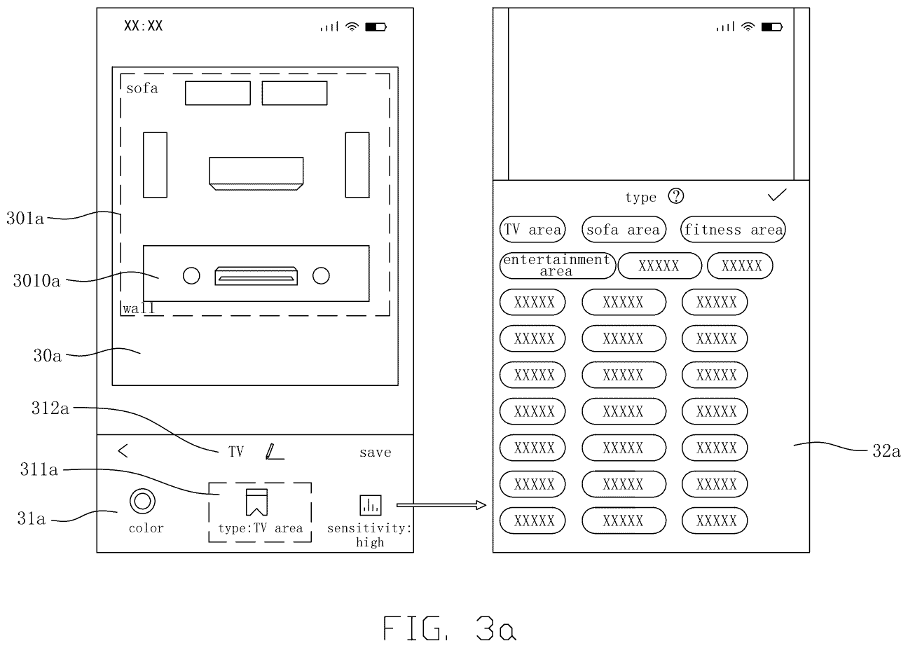

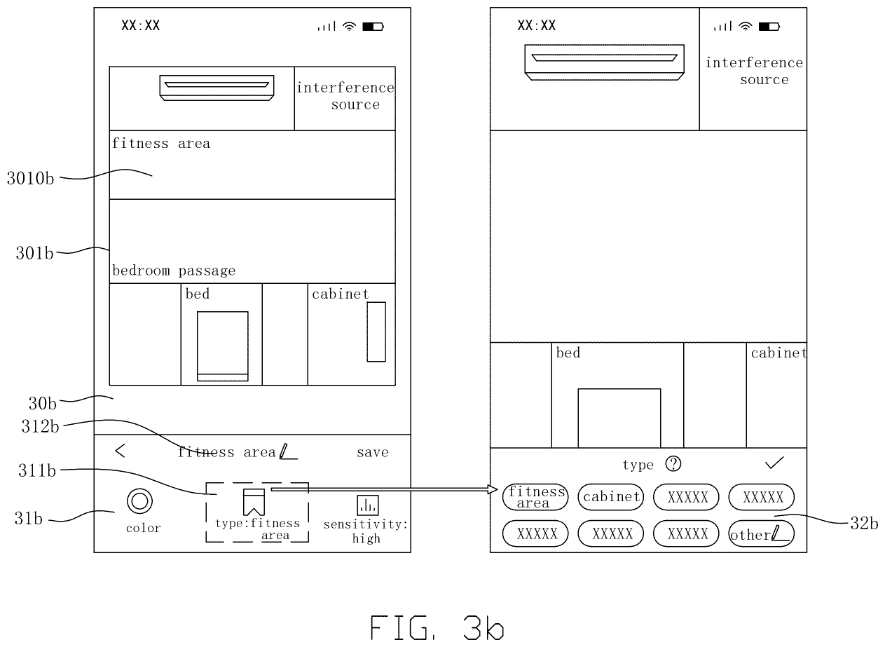

Specifically, as shown in FIG. 3a, a region management page 30a may include a page region of an equal scale plan view of a living room 301a. As shown in FIG. 3b, a region management page 30b may include a page region of an equal scale plan view of a bedroom 301b.
Step S202: obtaining a user selection of an arbitrary area within the spatial region, and generating a custom region.

In an embodiment, a custom region is a part of a region in a region management page, that is, a plurality of custom regions may be included in a region management page; in another embodiment, a custom region is a region displayed by an entire region management page, that is, only one custom region is included in a region management page. This is not specifically limited in this embodiment.

It should be noted that a custom region may be any region selected in a region management page. To facilitate understanding, for example, in an application scenario, a computer device automatically sets a plurality of custom regions according to information in a region management page, including a sofa area, a TV area and a tea table area. At this time, the computer device acquires an operation of a user selecting a region including the sofa area, and then modifies the sofa area set by the computer device to a region corresponding to the selection operation of the user. In another application scenario, the computer device acquires an operation of the user selecting an upper half part of the region management page, and then the computer device generates a custom region corresponding to the upper half part.
Step S203: in response to a selection operation directed to the custom region, displaying a function configuration page for the custom region.

In an embodiment, a computer device responds to a selection operation. The selection operation may be triggered by a user by using an interactive device, or may be an operation pre stored in a storage space. For example, in an application scenario, a user touches a touch screen of a computer device, clicks a mouse, taps a keyboard or speaks to a microphone, to generate a selection operation. In another application scenario, a selection operation is pre stored in a storage space, and the computer device reads a pre stored selection operation and responds. This is not specifically limited in this embodiment.

In an embodiment, the computer device displays a function configuration page associated with a selected custom region according to the custom region targeted by the selection operation. To facilitate understanding, for example, in an application scenario, there are custom region A, custom region B and custom region C in a region management page, and a selection operation targets custom region B, then the computer device displays a function configuration page B associated with custom region B.

Specifically, a function configuration page is configured for displaying function items that need to be configured, and the function items may be, for example, a name, a style, a type, etc., which is not specifically limited in this embodiment. To further explain the function configuration page, for example, in an application scenario, after a computer device displays a function configuration page corresponding to a custom region according to a selection operation, a user may select a function item such as a name, and complete a configuration operation related to the name for the custom region.
Step S204: obtaining a function item selected on the function configuration page, and displaying, on the function configuration page, configured attribute information adapted to the function item for the custom region; wherein the attribute information is configured for target detection within each custom region.

In an embodiment, a plurality of function items are included in a function configuration page. After a computer device obtains attribute information corresponding to each function item, the computer device configures the custom region according to the attribute information, so as to complete configuration work of the custom region.

Wherein, a function item is a configuration item to be configured corresponding to a custom region, that is, a function option that needs to be configured for the custom region. Each function item has a function limiting effect on a different aspect of the custom region, and after configuration of the function item is completed, a function corresponding to the custom region is determined.

To facilitate understanding, for example, a function item may be a type configuration item of a custom region, and is configured for limiting a type of the custom region; a function item may be an attribute configuration item of a custom region, and is configured for limiting an attribute of the custom region; a function item may further be a display color configuration item of a custom region, etc., which is not specifically limited in this embodiment.

After a function item is selected, the computer device may configure attribute information of the selected function item. Wherein, the attribute information refers to attributes of each function item, and may also be understood as that the attribute information is configuration information of each function item. For example, in an application scenario, a function item corresponds to a plurality of preset attribute information, and the computer device completes configuration of a function item corresponding to a custom region according to selected attribute information. In another application scenario, the computer device generates corresponding attribute information according to acquired information or information input by an external device, so as to complete configuration of a function item corresponding to a custom region.

To facilitate understanding, for example, in an application scenario, each function item is preset with a plurality of attribute information for a user to select. After the computer device obtains attribute information selected by the user, the computer device determines the corresponding attribute information as a configuration result of the function item. After all function items are determined to have configuration results, the computer device determines that configuration of a currently selected custom region is completed.

Wherein, for a configured custom region, automatic control of a smart device may be implemented through region monitoring. For example, in an application scenario, a custom region A includes a TV. The computer device determines that a person enters a space corresponding to custom region A according to a target signal for custom region A, and at this time, the computer device controls the TV to be turned on, to complete automatic control of the TV.

By setting no fixed limit on a position of a custom region in a region management page, any region of the region management page may be set as a custom region, and then the custom region is configured, so that control accuracy of a region where a smart device is located is improved.

In an embodiment, the function items include a spatial type. In an embodiment, a custom region includes a monitoring region selected for a spatial region, and the attribute information includes a region monitoring attribute. In an embodiment, step S204: obtaining a function item selected on the function configuration page, and displaying, on the function configuration page, configured attribute information adapted to the function item for the custom region, includes:
obtaining the spatial type selected on the function configuration page, and displaying, on the function configuration page, the configured region monitoring attribute adapted to the spatial type within the monitoring region.

Wherein, a spatial type is configured for adapting a corresponding region monitoring attribute to a space. The spatial type may be configured for representing a function type of a space, a structure type of a space, a position type of a space, etc. Monitoring regions having the same spatial type have the same configuration requirement for region monitoring attributes. Specifically, the spatial type may be, for example, a TV area, a sofa area, a bedroom area, a living room area, a first house type area, a first floor number area, etc.

Wherein, a monitoring region is a region that currently needs configuration of a region monitoring attribute and may perform target detection according to the region monitoring attribute. Specifically, the monitoring region may be any region selected through at least one drag, at least one click or other selection operation in a spatial region displayed in a region management page, and may include, for example, one region or a plurality of regions in a spatial region, where the plurality of regions may be regions connected to each other or regions not connected to each other. Therefore, a user may customize a monitoring region according to personal living habits, etc., so that flexibility of spatial configuration may be improved.

Specifically, as shown in FIG. 3a, according to a selection operation performed by a user on a spatial region 301a of a region management page 30a, the region management page 30a highlights a region 3010a selected by the selection operation, that is, highlights a region corresponding to the monitoring region 3010a. Specifically, for example, a region selected by the selection operation may be highlighted through a color. Wherein, a region monitoring attribute refers to a monitoring attribute of a region, and may specifically be various attributes configured for the region. For example, the region monitoring attribute may include sensitivity of a region monitoring region, etc. The region monitoring attribute is configured for performing target detection on each monitoring region according to the region monitoring attribute of each monitoring region.

Specifically, a selection operation on a monitoring region may include, but is not limited to, at least one drag, at least one click, etc.

Wherein, a function region management page includes a page for configuring a spatial type for a monitoring region. In an embodiment, a function configuration page includes a configuration item corresponding to a spatial type. Wherein, a configuration item corresponding to a spatial type may be an operation entry for configuring the spatial type. Specifically, a configuration item may include at least one of a plurality of selectable spatial types corresponding to the spatial type, a voice input button, and an input dialog box.

In an embodiment, the function configuration page includes a configuration item corresponding to the spatial type. The obtaining the spatial type selected on the function configuration page and displaying, on the function configuration page, the configured region monitoring attribute adapted to the spatial type for the monitoring region, includes:
in response to a trigger operation for a configuration item corresponding to the spatial type, displaying a spatial type configuration page; the spatial type configuration page comprising a plurality of selectable spatial types;
in response to a selected one of the plurality of selectable spatial types, displaying, on the function configuration page, the spatial type configured for the monitoring region;
displaying, on the function configuration page, an automatically configured region monitoring attribute adapted to the spatial type for the monitoring region.

Wherein, a configuration item corresponding to a spatial type is a function item for configuring a spatial type of a monitoring region. A trigger operation on a configuration item corresponding to a spatial type may be triggered by a user or may be automatically triggered by a system. Specifically, for example, the computer device displays a spatial type configuration page in response to a click operation of a user on a configuration button corresponding to a configuration item for a spatial type in a function configuration page, or the computer device displays a spatial type configuration page in response to a trigger operation such as a long press operation of the user on a page region of a corresponding monitoring region that is highlighted in the function configuration page, or the computer device displays a spatial type configuration page in response to that no exit instruction is received within a preset time when a function configuration page for a selected monitoring region is displayed.

Specifically, taking a target space is a home and spatial regions is respective functional spaces in the home such as a living room and a bedroom as an example for illustration. For example, as shown in FIG. 3a, the computer device displays a region management page 30a, and after acquiring a region 3010a selected in a spatial region 301a, generates a custom selected monitoring region 3010a, and in response to a selection operation on the monitoring region 3010a, for example, a long press operation on the monitoring region 3010a, displays a function configuration page 31a for the selected monitoring region 3010a. In response to a trigger operation on a configuration item corresponding to a spatial type, for example, a click operation on a configuration button 311a, or a long press operation on the monitoring region 3010a, a spatial type configuration page 32a is displayed. The spatial type configuration page 32a includes a plurality of selectable spatial types, for example, selectable spatial types such as “TV area”, “sofa area”, “fitness area”, “entertainment area”, and “reading area”. The computer device displays, on the function configuration page 31a, a spatial type configured for the monitoring region 3010a in response to a selection operation on a selected spatial type, for example, a “TV area” selection operation, for example, a click operation, for example, displays the configured spatial type in a display region of the configuration button 311a, for example, “type: TV area”. In addition, on the function configuration page 31a, a region monitoring attribute automatically configured for the monitoring region 3010a and adapted to the spatial type is displayed, for example, “sensitivity: high” is displayed. If a save operation displayed on the function configuration page 31a by a user is received, for example, a “save” button on the function configuration page 31a is clicked, a spatial type of the custom generated monitoring region 3010a is stored as a TV area, and sensitivity of the monitoring region 3010a is stored as high. In an embodiment, the computer device may further display a configuration item 312a for a name of the monitoring region 3010a on the function configuration page 31a, and associate a name corresponding to an input operation with the monitoring region 3010a after receiving an input operation on the configuration item for displaying the name of the monitoring region 3010a.

For another example, as shown in FIG. 3b, the computer device displays a region management page 30b, and after acquiring a region 3010b selected in a spatial region 301b, generates a custom selected monitoring region, and in response to a selection operation on the monitoring region, for example, a long press operation on the selected region 3010b, the computer device displays a function configuration page 31b for the selected monitoring region. In response to a trigger operation on a configuration button 311b of a configuration item corresponding to a spatial type, a spatial type configuration page 32b is displayed. The spatial type configuration page 32b includes a plurality of selectable spatial types, for example, selectable spatial types such as “TV area”, “sofa area”, “fitness area”, “entertainment area”, and “reading area”. The computer device displays, on the function configuration page 31b, a spatial type configured for the monitoring region in response to a selection operation on a selected spatial type, for example, a “fitness area” selection operation, for example, “type: fitness area” is displayed on the function configuration page 31b; on the function configuration page 31a, a region monitoring attribute automatically configured for the monitoring region and adapted to the spatial type is displayed, for example, “sensitivity: high” is displayed. In an embodiment, the computer device may further display a configuration item 312b for a name of the monitoring region 3010b on the function configuration page 31b, and display a name corresponding to an input operation in the monitoring region 3010b, for example, “fitness area”, and associate the name corresponding to the input operation with the monitoring region 3010b after receiving an input operation on the configuration item for displaying the name of the monitoring region 3010b.

In an embodiment, displaying, on the function configuration page, the configured region monitoring attribute adapted to the spatial type for the monitoring region includes:
obtaining a predetermined mapping relationship between spatial types and region monitoring attributes;
based on the predetermined mapping relationship, displaying, on the function configuration page, an automatically configured region monitoring attribute adapted to the spatial type for the monitoring region.

Wherein, the region monitoring attribute is configured for performing target detection on each monitoring region according to the region monitoring attribute of each monitoring region. Specifically, the region monitoring attribute may be, for example, high sensitivity, low sensitivity, etc.

Wherein, a predetermined mapping relationship between the spatial type and the region monitoring attribute refers to a correspondence that is predetermined and stored between the spatial type and the region monitoring attribute before spatial configuration is performed. The mapping relationship between the spatial type and the region monitoring attribute may be set in a personalized manner by a user, or may be obtained by a system through statistical data analysis. Specifically, for example, a region monitoring attribute corresponding to a spatial type of a TV area is high sensitivity, and a region monitoring attribute corresponding to a spatial type of a fitness area is low sensitivity, etc.

Wherein, the mapping relationship between the spatial type and the region monitoring attribute is obtained through a relationship configuration step.

In an embodiment, the relationship configuration step includes: obtaining environmental signals corresponding to spatial regions of a plurality of spatial types, and determining a mapping relationship between each spatial type and the region monitoring attribute based on the environmental signals corresponding to the spatial regions of the plurality of spatial types.

Wherein, an environmental signal of a spatial region is a detection signal collected by a detection device in the spatial region. An environmental signal corresponding to a spatial region may include, for example, an echo signal received after a millimeter wave radar device transmits a Frequency Modulated Continuous Wave (FMCW) signal in the spatial region, and may further include image information collected by an image collection device in the spatial region, etc.

Specifically, in an embodiment, the method obtains the predetermined mapping relationship between spatial types and region monitoring attributes through a relationship configuration step. The relationship configuration step, includes:
obtaining environmental signals corresponding to spatial regions of a plurality of spatial types;
determining, based on the environmental signals, activity state features and interference features of a target object in each spatial region;
determining, based on a relationship between an activity state features and an interference feature of the target object in each spatial region, mapping relationships between various spatial types and region monitoring attributes.

Wherein, an activity state feature of a target object under a spatial region is a feature of an activity performed by the target object under the spatial region. In an embodiment, a computer device may process an echo signal received after a millimeter wave radar device transmits a Frequency Modulated Continuous Wave (FMCW) signal in a spatial region, to obtain a point cloud distribution state of the target object, so as to acquire an activity state feature of the target object under each spatial region. Specifically, an activity performed by a target object may include, for example, walking, exercising or being still, etc. An activity state feature of a target object may include, for example, high point cloud complexity, low point cloud complexity, etc.

Specifically, for example, a person to be tested is allowed to be still, walk and exercise in spatial regions respectively, and the computer device may obtain point cloud distribution states of a human body in a still state, a walking state and an exercising state. After analyzing the point cloud distribution states of the person to be tested, the computer device may obtain features of human bodies in different activity states: a moving human body has a large quantity of point clouds, an obvious speed and a large signal to noise ratio, that is, the point cloud complexity is high; a still human body has a small quantity of point clouds with speeds and a small quantity of still point clouds, a low signal to noise ratio and simple point clouds, that is, the point cloud complexity is low.

Wherein, an interference feature refers to a degree to which an interference source interferes with a target detection result of a target object. In an embodiment, the computer device may process or analyze image information in an environmental signal to obtain an interference source in a spatial region, for example, obtain that an interference source in a fitness area is a green plant, and obtain an interference feature under each spatial region according to a pre stored mapping relationship between interference sources and interference features. Specifically, the interference feature may be, for example, a weak interference feature, a strong interference feature, etc.

Specifically, in an embodiment, the relationship configuration step includes: determining a mapping relationship between various spatial types and activity state features of a target object based on a mapping relationship between spatial types and region activity attributes and a mapping relationship between each region activity attribute and the activity state features of the target object; determining an activity state feature and a corresponding interference feature of a target object corresponding to each spatial type based on the mapping relationship between the various spatial types and the activity state features of the target object and a mapping relationship between each spatial type and the interference feature; and determining a mapping relationship between various spatial types and region monitoring attributes based on a mapping relationship between each activity state feature and interference feature of the target object and the region monitoring attribute.

Wherein, a region activity attribute refers to an attribute of an activity performed by a target object in a spatial region. In an embodiment, a computer device may determine a region activity attribute according to point cloud features, image features, etc. of a target object in an environmental signal of a spatial region. Specifically, for example, a region activity attribute of a fitness area may be running, and a region activity attribute of a reading area may be sitting still, etc.

The mapping relationship between the region activity attribute and the activity state feature of the target object refers to the correspondence between the region activity attribute and the activity state feature of the target object. The mapping relationship is used to confirm the activity state feature of the target object according to the region activity attribute. Specifically, for example, if the region activity attribute is “running”, the corresponding activity state feature is “high point cloud complexity”.

Specifically, the mapping relationship between each region activity attribute and the activity state feature of the target object may be established through the activity state features corresponding to the tested target object when it is active in each monitoring region. For example, the tested human body usually runs in the fitness area; during running the human point cloud quantity is large, the speed is obvious, and the signal to noise ratio is high—i.e., the point cloud complexity is high. The tested human body is often static in the sleep area; when static the human body has few point clouds with speed, the static point clouds are also few, and the signal to noise ratio is low—i.e., the point cloud complexity is low.

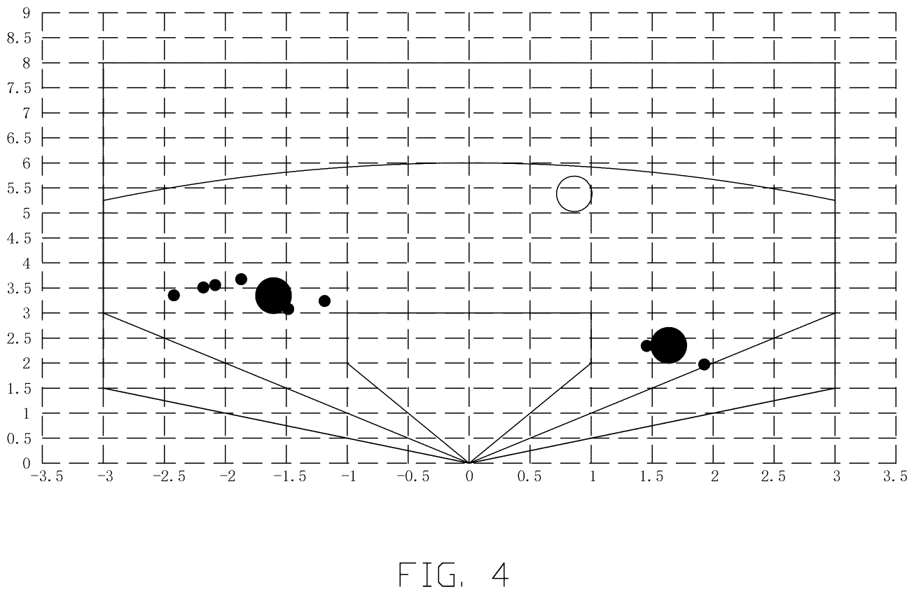

In one embodiment, the mapping relationship between each region activity attribute and the activity state feature of the target object is established by the computer device through the activity state features corresponding to the tested target object when it is active in the monitoring regions under the respective region activity attributes. Specifically, as shown in FIG. 4, the computer device may build a floor plan of the test space and obtain the activity state features corresponding to the tested human body when it is active in the test space. In FIG. 4 the solid large circle represents a moving human body, the hollow large circle represents a static human body, and the solid small dots represent point clouds. As illustrated, around the solid large circle there are many solid small dots with speed. Therefore the computer device may obtain that the moving human body has high point cloud complexity and the static human body has low point cloud complexity. Since the tested human body usually runs in the fitness area and during running the human point cloud quantity is large, the speed is obvious, and the signal to noise ratio is high—i.e., the point cloud complexity is high—and since the tested human body is often static in the sleep area and when static the human body has few point clouds with speed, the static point clouds are also few, and the signal to noise ratio is low—i.e., the point cloud complexity is low—the computer device may, for example, establish the mapping relationship between “running” and “high point cloud complexity” and establish the mapping relationship between “sleep” and “low point cloud complexity”, etc.

The mapping relationship between the spatial type and the activity state feature of the target object refers to the correspondence between the spatial type and the activity state feature of the target object. The mapping relationship is used to confirm the activity state feature of the target object according to the spatial type. The mapping relationship between the spatial type and the activity state feature of the target object may be established through the activity state features corresponding to the tested target object when it is active in the monitoring regions of each spatial type, or may be customized and set according to user instructions.

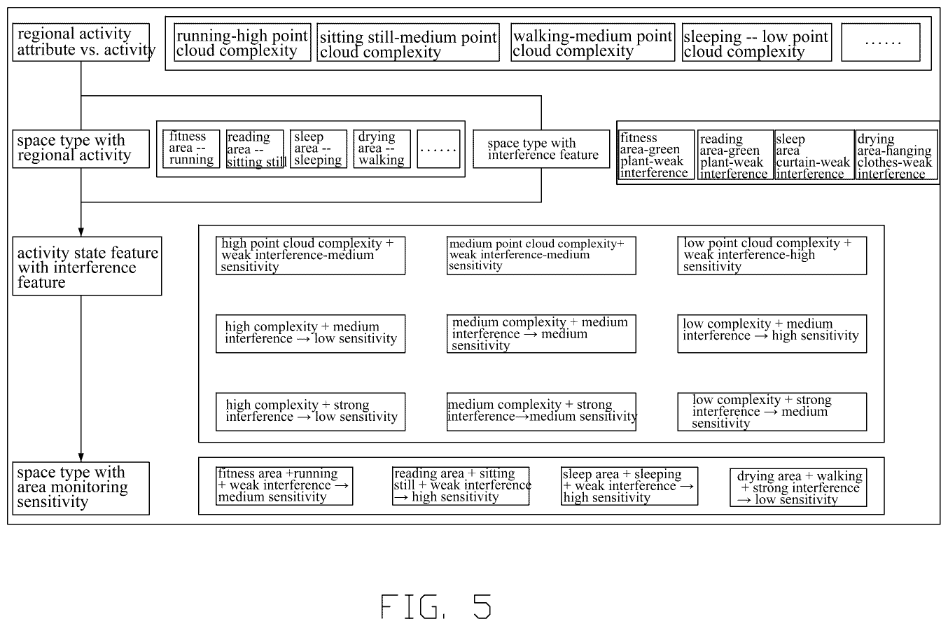

Specifically, as shown in FIG. 5, when the spatial type is “fitness area” the computer device, based on the mapping relationship between spatial type and region activity attribute (e.g., the mapping relationship between fitness area and running) and the mapping relationship between region activity attribute and activity state feature of the target object (e.g., the mapping relationship between running and high point cloud complexity), determines the mapping relationship between spatial type and activity state feature of the target object (e.g., fitness area corresponds to high point cloud complexity). The computer device, based on the mapping relationship between spatial type and activity state feature of the target object (e.g., fitness area corresponds to high point cloud complexity) and the mapping relationship between spatial type and interference feature (e.g., fitness area corresponds to weak interference feature), determines the mapping relationship among spatial type, activity state feature and interference feature (e.g., fitness area corresponds to high point cloud complexity and weak interference feature). The mapping relationship between spatial type and interference feature may be obtained through the mapping relationship between spatial type and interference source and the mapping relationship between interference source and interference feature; for example, through the mapping relationship between fitness area and green plants and the mapping relationship between green plants and weak interference feature, the mapping relationship between fitness area and weak interference feature is obtained. In addition, based on the mapping relationship among activity state feature, interference feature and region monitoring attribute (e.g., high point cloud complexity & weak interference feature correspond to medium region sensitivity), the mapping relationship between spatial type and region monitoring attribute is determined (e.g., fitness area corresponds to medium region sensitivity).

In one embodiment, the function configuration page includes a region monitoring attribute item; after obtaining the spatial type selected on the function configuration page and displaying, on the function configuration page, the configured region monitoring attribute adapted to the spatial type for the monitoring region, the method further includes:
in response to a trigger operation on the region monitoring attribute item, displaying an attribute configuration page for the region monitoring attribute;
in response to an adjustment operation on the region monitoring attribute item on the attribute configuration page, displaying the adjusted region monitoring attribute under the region monitoring attribute item.

The trigger operation on the region monitoring attribute item is an operation for triggering configuration of the region monitoring attribute of the monitoring region. The trigger operation on the region monitoring attribute item may be triggered by a user or may be automatically triggered by the system.

Specifically, for example, the computer device, in response to the user's click operation on a configuration button corresponding to the region monitoring attribute configuration item on the function configuration page, displays the attribute configuration page, or, in response to the user's trigger operation (e.g., long press operation) on the page area corresponding to the monitoring region displayed on the function configuration page, displays the attribute configuration page. Specifically, the computer device may display, on the attribute configuration page, a plurality of selectable region monitoring attributes, such as medium region sensitivity, low region sensitivity, etc.

The adjustment operation on the region monitoring attribute item on the attribute configuration page is an operation for adjusting the region monitoring attribute. Specifically, it may be, for example, a selection operation on a selectable region monitoring attribute or a voice input operation, etc.

The region configuration method of the present embodiment includes: displaying a region management page; the region management page including a spatial region corresponding to a target space; obtaining any region selected in the spatial region to generate a custom selected monitoring region; in response to a selection operation on the monitoring region, displaying a function configuration page for the selected monitoring region; obtaining the spatial type selected on the function configuration page, and displaying, on the function configuration page, the configured region monitoring attribute adapted to the spatial type for the monitoring region; the region monitoring attribute being used to perform target detection for each monitoring region according to the region monitoring attribute of each monitoring region. Therefore, the region monitoring attribute adapted to the spatial type may be assigned to the monitoring region, thereby improving the flexibility of spatial configuration. In addition, the present embodiment also generates a custom selected monitoring region through any region displayed in the region management page, which improves the flexibility and operation convenience of generating the monitoring region. Moreover, selecting the spatial type on the function configuration page and displaying, on the function configuration page, the configured region monitoring attribute adapted to the spatial type for the monitoring region further improves configuration flexibility and operation convenience.

In one embodiment, the custom region includes a monitoring region, and step S202, obtaining user selection of an arbitrary area within the spatial region to generate a custom selected custom region, includes:

displaying, on the region management page, at least one monitoring region set within the monitoring range of a sensing device in the target space; in response to a trigger operation for setting the monitoring region on the region management page, marking a set monitoring region as a target monitoring region, and displaying, on the region management page, the target monitoring region.

In the present embodiment, the specific application scenario may be a region classification scenario in the smart home field. In some related technologies, to achieve region classification for smart homes, it is necessary to pre draw a spatial structure diagram of the current home space, and then classify the current home space according to the number of persons detected in each region of the spatial structure diagram and the positions of the persons, so as to determine the region type of each region in the spatial structure diagram in the home environment, where the region type may be the functional type of different functional regions in the home environment.

It should be noted that, in existing technical solutions for realizing region classification for smart homes, on the one hand, pre drawing the spatial structure diagram of the home space requires manual region classification of the current space in advance, and the specific region type after classification is not determined at the manual region classification stage, so the learning cost for region classification of the home space is increased. On the other hand, the number of persons and personnel information in a certain region of the spatial structure diagram are directly detected and used as the detection information of the region, and the specific region type of the region is judged according to the detection information; however, when obtaining the number of persons detected in each region and the positions of the persons, the method of directly detecting the persons in the current home space by using a collection device has low detection sensitivity and poor data accuracy, which in turn leads to low accuracy in classifying the spatial region.

Therefore, the present disclosure embodiment displays the region management page and shows at least one monitoring region on the region management page. The monitoring region is obtained by automatically collecting target position information of the target object within the monitoring range for a period of time by the monitoring device and automatically performing data analysis on the target position information of the target object within the monitoring range to determine the corresponding monitoring region. The embodiment of the present disclosure not only automatically collects data through the monitoring device without pre inputting the spatial structure diagram of the current space, thereby reducing the cost of region classification for the current space, but also uses the target position information after data analysis as the classification basis, thereby improving the data accuracy for region classification and in turn improving the accuracy of region classification. Specifically, the accuracy of data and the accuracy of region classification are improved by: after obtaining the target position information of the target object within the monitoring range of the sensing device, performing data statistics on the target position information of the target object, and performing data analysis on the data set corresponding to the target position information of the target object after statistics to determine the monitoring region within the monitoring range. The data analysis based on the data set corresponding to the target position information of the target object improves the detection accuracy, optimizes the classification effect for classifying the spatial region, and quickly marks the monitoring region as the target monitoring region, thereby improving the accuracy and efficiency of classifying the spatial region. For the specific process please continue to refer to the following steps.

It should be noted that, in the prior art, in a home scenario the unclassified spatial region and/or the classified region have little interaction with the user. In the embodiment of the present disclosure, the region management page is used to display the unmonitored spatial region in the home scenario and/or each spatial region that has been monitored and classified by the monitoring device. It may be understood that the region management page may display the unclassified spatial region and/or the classified monitoring region within the monitoring range of the sensing device, and the user may implement corresponding interaction with the unclassified spatial region and/or the classified monitoring region through the region management page.

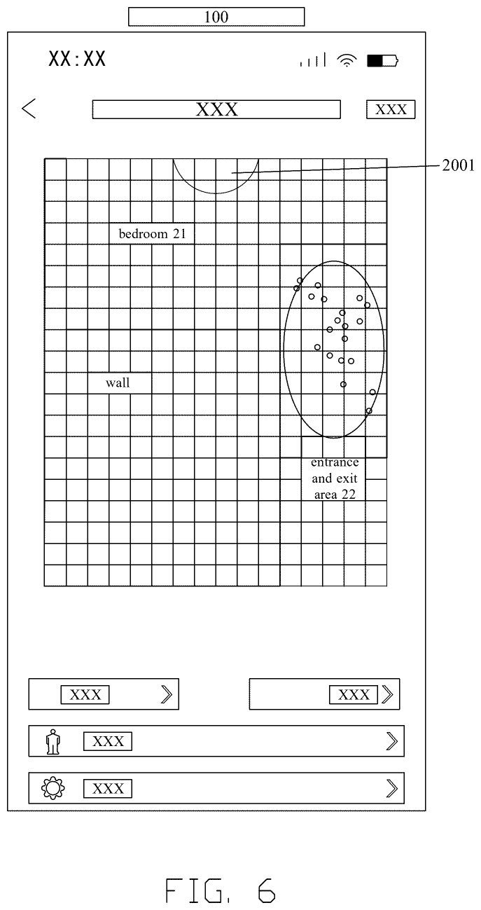

To better understand the technical solution of the present disclosure, please refer to FIG. 6. FIG. 6 is a schematic diagram of a scenario of the region configuration method of the present disclosure. In the region management page 100, within the monitoring range of the millimeter wave radar 2001, two monitoring regions—the bedroom 21 and the entrance and exit area 22—may be included, and even the walls within the monitoring range may be identified, recorded and displayed on the region management page. Specifically, when performing region classification for the indoor space, by performing data analysis on the target position information of the target object within the monitoring range of the millimeter wave radar 2001, it may be determined that a certain monitoring region within the monitoring range has a special function. For example, if it is detected that the number of persons entering and exiting a certain monitoring region within the monitoring range is high (the target position information of the persons is relatively dense), then the region may be marked as the entrance and exit area of the current room and displayed on the region management page as the entrance and exit area.

In the embodiment of the present disclosure, the phrase “in response to a trigger operation for setting the monitoring region on the region management page” is used to indicate the condition or state on which the performed operation depends. When the depended condition or state is satisfied, the one or more performed operations may be real time or may have a set delay. Unless otherwise specified, there is no limitation on the execution sequence of the plurality of operations performed.

It should be noted that the trigger operation for setting a monitoring region in the region management page refers to the operation triggered when a certain monitoring region is set as a target monitoring region in the region management page. Specifically, the trigger operation may be an automatic operation in which a monitoring region is automatically identified and set within the monitoring range of the monitoring device, or a manual operation in which the user sets the monitoring region through the region management page.

Further, after the trigger operation for setting a monitoring region in the region management page is triggered, the set monitoring region is marked as the target monitoring region and the marked monitoring region is displayed in the region management page. Displaying the target monitoring region in the region management page enhances user interaction in region management and improves user interactive experience.

In some embodiments, in response to the trigger operation for setting the monitoring region in the region management page, marking the set monitoring region as the target monitoring region includes:
in response to confirming the monitoring region within the monitoring range of the sensing device, triggering a push instruction;
in response to the push instruction, displaying a push window, wherein the push window is configured for displaying push information that the monitoring region is set as the target monitoring region;
in response to a trigger operation on a confirmation component in the push window, marking the monitoring region as the target monitoring region.

When the monitoring region is determined within the monitoring range of the sensing device, a corresponding push instruction is triggered. The manner of determining the monitoring region may be that the user manually sets it through a setting button on the region management page, or that the monitoring region is automatically identified within the monitoring range of the monitoring device and then automatically set. When the setting of the monitoring region is achieved, the push instruction is triggered; in response to the push instruction, a push window is displayed in the region management page, the push window being used to prompt the user whether to set the monitoring region as the target monitoring region. A confirmation component in the push window receives user authorization information; through a trigger operation on the confirmation component the user's authorization is obtained, and based on the authorization information the monitoring region is marked as the target monitoring region.

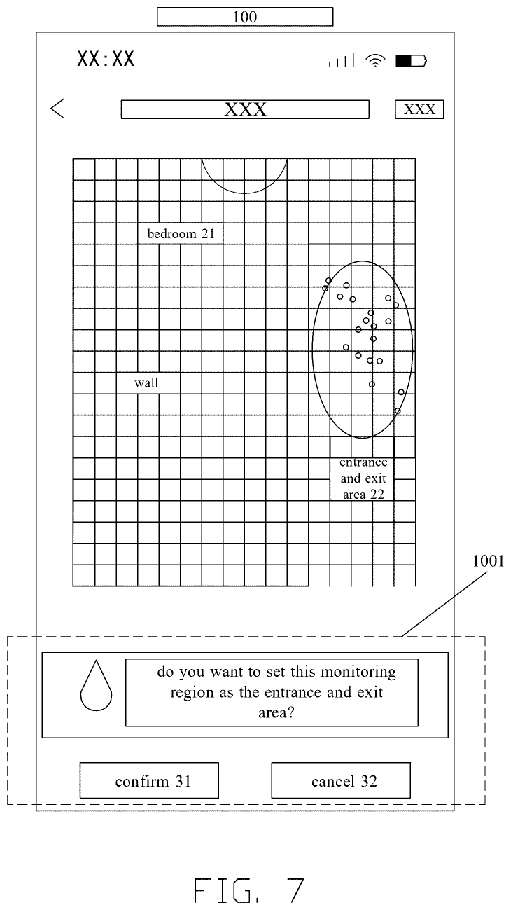

To better understand the technical solution of the present disclosure, reference may be made to FIG. 7, which is another schematic diagram of a scenario of the region configuration method of the present disclosure. In the region management page 100 there is a prompt window 1001 for prompting the user whether to set the current monitoring region (oval region) as an entrance and exit area. Upon receiving a trigger operation on the confirmation component 31, the current monitoring region is set as the entrance and exit area; upon receiving a trigger operation on the cancel component 32, if the monitoring region has already been set as the entrance and exit area, the setting of the current monitoring region as the entrance and exit area is cancelled; or, if the monitoring region has not been set as the entrance and exit area, the trigger operation for setting the monitoring region is ignored and the monitoring region is not set as the entrance and exit area.

In the present embodiment, description will be made from the perspective of a region setting apparatus. The region setting apparatus may be integrated in a terminal having a storage unit and a microprocessor and thus having computing capability, such as a tablet computer or a mobile phone. The terminal may open a live broadcast client; in the embodiment of the present disclosure the live broadcast client may be an audience client.

In one embodiment, displaying, on the region management page, at least one monitoring region set within the monitoring range of the sensing device in the target space includes:
obtaining target position information of a target object within the monitoring range of the sensing device when a state of the target object changes; performing data analysis on the obtained target position information to obtain a first monitoring region satisfying a preset condition, wherein the quantity of target position information in the first monitoring region is greater than a preset threshold; and displaying, on the region management page, at least one first monitoring region.

It should be noted that, in one embodiment, the region management page is used to display the monitoring region detected within the monitoring range of the sensing device. When region classification within the monitoring range is not completed, only one monitoring space detected in the current home space is displayed, and the monitoring space may be an unclassified spatial region. When region classification within the monitoring range is completed, at least one monitoring region set within the monitoring range of the sensing device in the current home space and the unclassified spatial region within the monitoring range are displayed.

In some specific embodiments, the region management page is used for the user to manage the monitoring regions in the home space. Through the region management page the user may manually set a certain region as a region type, the region type being the functional type of different functional regions in the home environment. The user may also, through the region management page, authorize marking a monitoring region automatically set within the monitoring range of the sensing device as a target monitoring region; through the user's authorization information on the region management page the monitoring region is marked as the target monitoring region, and the target monitoring region may also be a spatial region representing the functional type of different functional regions in the home environment.

In another embodiment of the present disclosure, the region management page includes a region editing page. Wherein the step of generating the custom region includes:
in response to a sliding operation on the region editing page, obtaining trajectory information corresponding to the sliding operation; generating a custom region associated with the sliding operation based on the trajectory information, and displaying, on the region editing page, the custom region.

The region editing page is used to edit the custom region. After editing, the custom region is generated and displayed on the region management page.

In one embodiment, a user uses an interaction device to perform a sliding operation, and the computer device, in response to the sliding operation, obtains trajectory information corresponding to the sliding operation. For ease of understanding, in an application scenario, the user touches the touch screen of the computer device with a finger or a stylus, at which moment the starting point of the sliding operation is generated. The user then moves the finger or stylus to form a sliding trajectory on the touch screen until the finger or stylus leaves the touch screen, generating the ending point of the sliding operation. The computer device identifies the sliding operation to obtain trajectory information having a starting point, a moving route and an ending point.

In another application scenario, the user moves a cursor in the region editing page by using a mouse so that the cursor forms a sliding trajectory, generating a sliding operation. The computer device obtains corresponding trajectory information according to the sliding operation. That is, the present embodiment does not specifically limit the interaction device or the generation process of the sliding operation.

In one embodiment, the trajectory information may represent a path having a starting point and an ending point, for example in the form of a line segment. In another embodiment, the trajectory information may represent a plurality of coordinate points. The present embodiment does not specifically limit this, as long as a region may be determined according to the trajectory information. The computer device determines the position where the custom region to be generated is located in the region editing page according to the trajectory information, and then displays the generated custom region on the region editing page.

In the present embodiment, the computer device responds to the sliding operation to obtain trajectory information corresponding to the sliding operation, and then generates and displays the custom region. The whole process is simple and fast, improving the generation efficiency of the custom region.

In another embodiment of the present disclosure, the region management page may be generated based on a spatial layout diagram.

In one embodiment, the step of generating the custom region corresponding to the sliding operation based on the trajectory information includes at least one of the following: determining a region mapped by the trajectory information as the custom region corresponding to the sliding operation; based on grid coordinate information corresponding to the trajectory information, determining a grid region traversed by the trajectory information, as the custom region corresponding to the sliding operation.

In one embodiment, the trajectory information represents a line segment having a starting point and an ending point. Specifically, the line segment may be straight or curved, and the present embodiment does not specifically limit this. The computer device determines the custom region according to the region enclosed by the line segment, namely the region mapped by the trajectory information.

For ease of understanding, in an application scenario, the computer device identifies a closed figure enclosed by the trajectory information and determines the region corresponding to the closed figure as the custom region.

In another application scenario, the computer device identifies a figure enclosed by the trajectory information and automatically connects the starting point and the ending point in the trajectory information to form a closed figure, and determines the region corresponding to the closed figure as the custom region.

In other application scenarios, the computer device identifies a figure enclosed by the trajectory information and extends the region corresponding to the notch of the figure; after extending to the boundary line of the region editing page, the closed region formed by the figure and the boundary line is determined as the custom region. That is, the present embodiment does not specifically limit the mapping process.

In one embodiment, the trajectory information refers to the path trajectory passed by the user operation. Where the grid coordinates passed by the path trajectory are determined, the grid coordinate information corresponding to the trajectory information may be obtained. The computer device determines the custom region according to the grid coordinate information. For ease of understanding, in an application scenario, the user selects two positions in the region editing page to generate two grid coordinates. The computer device takes the two grid coordinates as opposite corners to form a rectangular region and determines the rectangular region as the custom region.

In another application scenario, the user selects two positions in the region editing page to generate two grid coordinates. The computer device takes the distance between the two grid coordinates as a diameter and the midpoint of the line connecting the two grid coordinates as a center to form a circular region and determines the circular region as the custom region.

In other application scenarios, the user first determines two grid coordinates to generate the positions of two opposite sides of the rectangle in the trajectory information; the user then determines two grid coordinates to generate the positions of the other two opposite sides of the rectangle in the trajectory information. The computer device determines the custom region according to the positions of the four sides. That is, the present embodiment does not limit the specific process of determining the custom region according to the grid coordinate information.

The step of determining the region mapped by the trajectory information as the custom region corresponding to the sliding operation and the step of determining, according to the grid coordinate information corresponding to the trajectory information, the grid region traversed by the trajectory information as the custom region corresponding to the sliding operation are in an OR relationship and may also coexist. For example, a user slides a single finger on the touch screen to generate trajectory information. The computer device determines the custom region according to the region mapped by the trajectory information, namely the region enclosed by the trajectory information. When the user slides two fingers on the touch screen, the computer device determines the custom region according to the starting grid coordinates corresponding to each finger.

In the present embodiment, the custom region is determined in a variety of manners through the trajectory information, which is conducive to improving the flexibility and convenience of dividing the custom region, thereby improving the generation efficiency of the custom region.

In another embodiment of the present disclosure, the step of obtaining the function item selected on the function configuration page and displaying the configured attribute information adapted to the function item for the custom region, includes:

in response to a trigger operation on a selected function item on the function configuration page, displaying an attribute selection page corresponding to the selected function item; obtaining attribute information corresponding to the current function item selected on the attribute selection page, and configuring, based on the attribute information, a selected custom region for the current function item; and displaying, on the function configuration page, the configured attribute information.

Specifically, after the user clicks a certain function item on the function configuration page, the computer device displays the attribute selection page corresponding to the function item. Where the attribute selection page contains a plurality of attribute information for the function item.

In one embodiment, the size of the attribute selection page is the same as the maximum display area of the computer device, that is, after the computer device displays the attribute selection page, the attribute selection page covers other pages.

In another embodiment, the size of the attribute selection page may be smaller than the maximum display area of the computer device, that is, when the computer device displays the attribute selection page, the user may still see the display of other information.

The present embodiment does not specifically limit the display process of the attribute selection page.

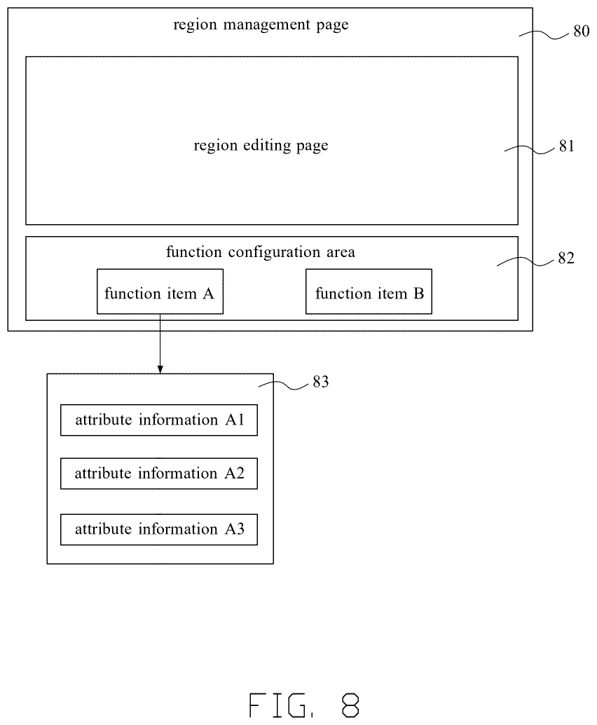

In one embodiment, after the computer device obtains the attribute information, the attribute information is configured as the current function item. For ease of understanding, in an application scenario, as shown in FIG. 8, the computer device displays the region management page 80, and the region management page 80 includes the region editing page 81 and the function configuration page 82. Where the function configuration page 82 displays function item A and function item B. When the user's trigger operation corresponds to function item A of custom region A, the computer device displays the attribute selection page A20 associated with function item A. The attribute selection page A20 contains attribute information A1, attribute information A2 and attribute information A3. After the user selects attribute information A3, the computer device determines attribute information A3 as the configuration result of function item A of custom region A.

In the present embodiment, by displaying the attribute selection page, the computer device facilitates the user to select the attribute information of the current function item, thereby improving the efficiency of configuring the function item.

In one embodiment of the present disclosure, the function item includes a type configuration item, and the attribute information includes type attribute information. The step of obtaining the attribute information corresponding to the current function item selected on the attribute selection page includes at least one of the following:
in response to detecting a trigger operation on the type configuration item, displaying a type selection page corresponding to the type configuration item, wherein the type selection page includes a plurality of selectable type options; in response to a selection operation on a type option in the type selection page, configuring a selected type option as the type attribute information for the custom region; and, in response to a trigger operation on an editing entry in the type selection page, displaying an editing page, and configuring the type attribute information input on the editing page as the type attribute information for the custom region.

In one embodiment, the type configuration item is used to configure the type of the custom region. Specifically, for example, in an application scenario, the types of the custom region include sofa area, TV area, study room and tea table area, and the present embodiment does not specifically limit this.

In one embodiment, the type options are all preset, and the user selects among the type options displayed by the computer device. The computer device, in response to the type option selected by the user, completes the configuration of the type configuration item of the custom region.

In another embodiment, the type options include a custom option. After the user selects the custom option, the computer device displays an editing page, and then determines the content edited by the user as the type data information of the custom region, thereby completing the configuration of the type configuration item of the custom region.

It may be understood that the type selection page may further include an editing entry. The editing entry is used to instruct the user to enter the editing page to customize and edit the type data information of the region, etc.

When the computer device detects a trigger operation on the editing entry in the type selection page, the editing page may be displayed. Thus the user may input configuration information for the function item on the editing page. The configuration information for the function item may include the type configuration item. The computer device then obtains the type attribute information input by the user on the editing page, and determines the content edited by the user as the type data information of the custom region, thereby completing the configuration of the type configuration item of the custom region.

By providing the type configuration item, the type of the custom region is limited, which is conducive to subsequently configuring other function items according to the type of the custom region. In addition, providing a variety of manners for configuring the type configuration item is conducive to improving the flexibility and efficiency of configuring the type configuration item.

In one embodiment of the present disclosure, the function item includes a region attribute configuration item and a region monitoring attribute item, and the attribute information includes region attribute information and a region monitoring attribute. The step of obtaining the attribute information corresponding to the current function item selected on the attribute selection page, and configuring, based on the attribute information, a selected custom region for the current function item, may include:
in response to detecting a trigger operation on the region attribute configuration item, displaying a region attribute selection page corresponding to the region attribute configuration item; the region attribute selection page including a plurality of selectable region attribute types; obtaining a region attribute type selected on the region attribute selection page, and configuring the region attribute type as the region attribute information for the custom region; and displaying, on a page corresponding to the region monitoring attribute item, a configured region monitoring attribute adapted to the region attribute type for the custom region; wherein the region monitoring attribute is configured for target detection within each custom region according to the region monitoring attribute within each monitoring region.

In one embodiment, the region attribute selection page includes a plurality of selectable region attribute types. In one embodiment, the region attribute configuration item is used to configure the region attribute of the custom region. Specifically, for example, in an application scenario, the region attributes of the custom region include monitoring region, edge area, interference area and entrance/exit, and the present embodiment does not specifically limit this.

It should be noted that, in one embodiment, the monitoring region refers to a region that needs to be monitored to achieve automatic control; the interference area, edge area and entrance/exit refer to regions that do not need to be monitored.

The region attribute type refers to the type of the custom region attribute, namely, what type of attribute the custom region belongs to. For ease of understanding, for example, the region attribute types include monitoring class and non monitoring class. The monitoring class means that the custom region needs to be monitored by using a smart device, such as human body position monitoring; the non monitoring class means that the custom region does not need to be monitored by using a smart device. That is, when the custom region needs to be monitored, the region attribute of the custom region is a monitoring attribute, and the corresponding region attribute type is the monitoring class. The non monitoring class includes, but is not limited to, interference area, edge area and entrance/exit, and the present embodiment does not specifically limit this.

The region attribute information refers to the configuration result information of the region attribute type of the custom region. For example, when the region attribute type “monitoring region” is selected, the computer device takes “monitoring region” as the configuration result of the region attribute type, and at this moment the region attribute information is the monitoring region.

In one embodiment, the region attribute types are preset, and the user selects among the region attribute types displayed by the computer device. The computer device, in response to the region attribute type selected by the user, completes the configuration of the region attribute configuration item of the custom region.

The region monitoring attribute is used to represent the monitoring sensitivity of the custom region. In one embodiment, the region monitoring attributes include high, medium and low. The low monitoring sensitivity level means that when the region detection device detects a large motion of a human body in the corresponding region, a control instruction for the smart device will not be triggered. The high monitoring sensitivity level means that when the region monitoring device detects a motion of a human body in the corresponding region, a control instruction for the corresponding smart furniture is triggered immediately.

In one embodiment, the region attribute types include monitoring region and auxiliary area. The auxiliary area includes edge area, interference area and entrance/exit. The edge area refers to the edge of a region, such as walls and windows in a room; the interference area refers to a region containing an interference source, such as an area where a curtain or a fan is located; the entrance/exit refers to the entrance and exit of the space corresponding to the custom region.

After the computer device completes the configuration of the region attribute configuration item of the custom region, the region monitoring attribute is automatically configured according to the region attribute type. In one embodiment, the region monitoring attribute includes at least one of monitoring region and interference area; the above method further includes: when the region attribute configuration item of the custom region is configured as the monitoring region, determining the region monitoring attribute of the custom region as a high configuration result; when the region attribute configuration item of the custom region is configured as the interference area, determining the region monitoring attribute of the custom region as a low configuration result.

For example, in an application scenario, when the region attribute configuration item of the custom region is configured as the monitoring region, the computer device takes “region monitoring attribute=high” as the configuration result of the region monitoring attribute item of the custom region; when the region attribute configuration item of the custom region is configured as the interference area, the computer device takes “region monitoring attribute=low” as the configuration result of the region monitoring attribute item of the custom region.

In the present embodiment, by displaying the region attribute selection page, the computer device facilitates improving the efficiency of selecting the region attribute type, thereby improving the configuration efficiency of the region attribute configuration item. In addition, automatically determining the region monitoring attribute of the region monitoring attribute item according to the region attribute type helps reduce the user's configuration workload and improve configuration efficiency.

In another embodiment of the present disclosure, after obtaining the region attribute type selected on the region attribute selection page and configuring the region attribute type as the region attribute information for the custom region, the method further includes:
in response to detecting a trigger operation on the region monitoring attribute item, displaying a region monitoring selection page corresponding to the region monitoring attribute item;
wherein the region monitoring selection page includes a plurality of selectable region monitoring options.

in response to a selection operation on a region monitoring option in the region monitoring selection page, configuring the selected region monitoring option as a current region monitoring attribute for the custom region.

In one embodiment, the user may modify the region monitoring option of the custom region according to a selection operation, thereby re configuring the region monitoring attribute of the custom region, which is conducive to improving configuration flexibility and making the configuration result meet the user's needs.

In another embodiment of the present disclosure, after obtaining the attribute information corresponding to each function item selected on the function configuration page and configuring the selected custom region based on the attribute information, the method further includes:
obtaining target signals of each custom region in the current space; performing feature extraction on the target signals to obtain target features of the target object under each custom region; determining a target detection result corresponding to each custom region according to the region monitoring attribute corresponding to each custom region and the target features; and when the target detection result satisfies a trigger condition in a corresponding device control scheme, controlling a corresponding smart device to execute the device control scheme.

In one embodiment, the target signal is the detection signal of a human body in the actual space corresponding to the custom region, detected by the monitoring device. In another embodiment, the target signal may also include detection of a pet. Specifically, the target signal is used to represent the position of a human body and/or a pet, the motion, the distance from the smart device, etc., and the present embodiment does not specifically limit this.

In one embodiment, the region attribute type of the custom region includes the monitoring class. The monitoring class indicates that the corresponding custom region needs to be subjected to target detection. The step of obtaining the target signals of each custom region in the current space may include: obtaining the target signals of each custom region whose region attribute type is the monitoring class in the current space.

The computer device completes feature extraction by using feature recognition software or a feature recognition model, and the present embodiment does not specifically limit this. The target object may be a human body or a pet, and the present embodiment does not specifically limit this. The target features may be the position of a human body, a human hand or the head of a pet, and the present embodiment does not specifically limit this.

For ease of understanding, in an application scenario, a smart device monitors a human body and generates a human body target signal, namely the target object is a human body. After the human body enters the room, the computer device obtains the human body target signal. Then the computer device processes the human body target signal by using a preset network model, recognizes the face of the human body, and takes the facial feature of the human body as the target feature.

In another application scenario, besides the face of the human body, the target features further include the hands and feet of the human body, namely the target features may be plural, and the present embodiment does not specifically limit this. In addition, after the computer device obtains the target features, feature information may be further obtained. For example, after the face of the human body is obtained, the orientation of the face of the human body may be obtained; after the hands of the human body are obtained, the positions of the hands of the human body, such as the height and the shape of the hands, may be known.

The target detection result includes the position where the target object is located, the distance between the target object and the smart device in the custom region, etc., and the present embodiment does not specifically limit this.

For ease of understanding, when a human body approaches the sofa area, the computer device determines the target detection result according to the region monitoring attribute of the sofa area and the hip of the human body. The hip of the human body is the target feature. When the region monitoring attribute is high, the distance between the hip of the human body and the surface of the sofa is determined as the target detection result; when the region monitoring attribute is medium, only when the height where the hip of the human body is located decreases, the distance between the hip of the human body and the surface of the sofa is determined as the target detection result; when the region monitoring attribute is low, only when the distance between the hip of the human body and the surface of the sofa is less than 20 cm, the distance between the hip of the human body and the surface of the sofa is determined as the target detection result.

For ease of understanding, the living room in a room is taken as a configuration region for specific description.

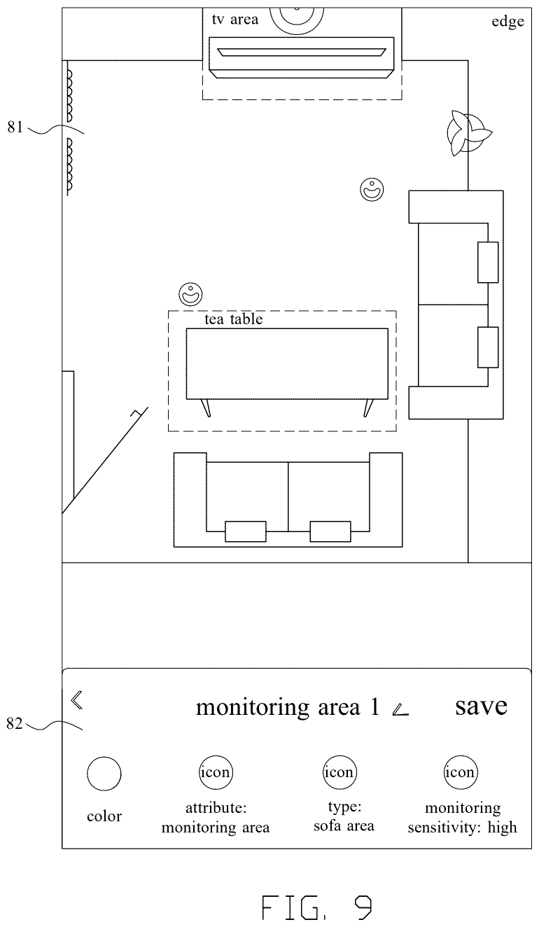

As shown in FIG. 9, the computer device displays the region management page of the living room area in the form of a picture. The region management page of the living room area includes the region editing page 81 and the function configuration page 82 located below the region editing page 81. The name of the custom region corresponding to the function configuration page may be “Monitoring Region 1”, and the name of the custom region may be edited by itself. Below the name of the custom region there are four function items: Color, Attribute, Type and Monitoring Sensitivity. Among them, Attribute is the region attribute configuration item, Type is the type configuration item, and Monitoring Sensitivity is the region monitoring attribute item. In the current function items, the computer device has configured the attribute information of each function item and displays the attribute information of Attribute, Type and Monitoring Sensitivity. Specifically, Attribute=Monitoring Region, Type=Sofa Area, Monitoring Sensitivity=High.

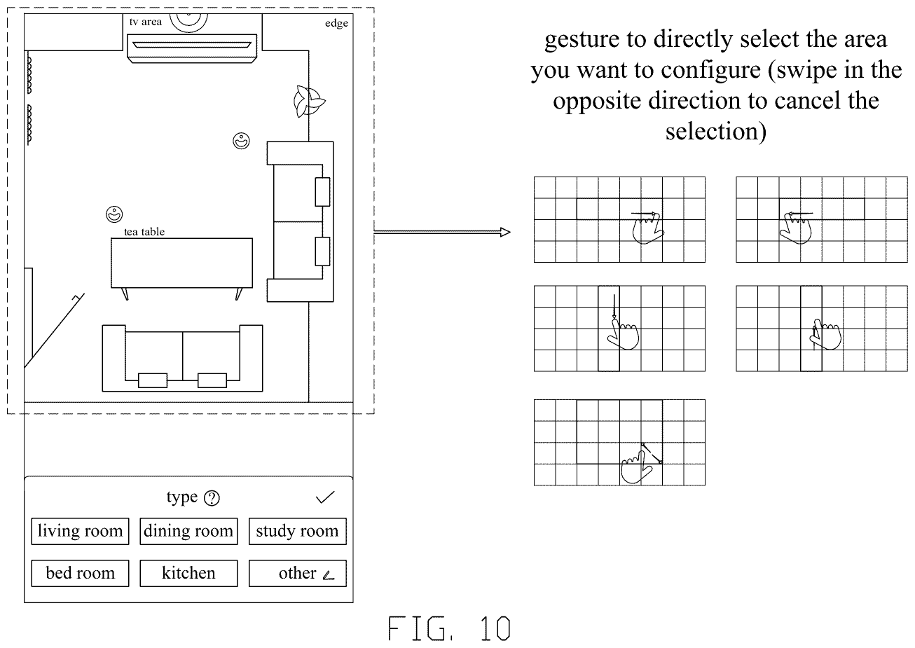

When the user wants to generate a custom region, as shown in FIG. 10, the user slides a finger on the display screen of the computer device to generate trajectory information, and the computer device generates the custom region based on the trajectory information and displays the custom region by shading it, so that the user may view it clearly. The user may also cancel the selected grid by sliding in the reverse direction or clicking again.

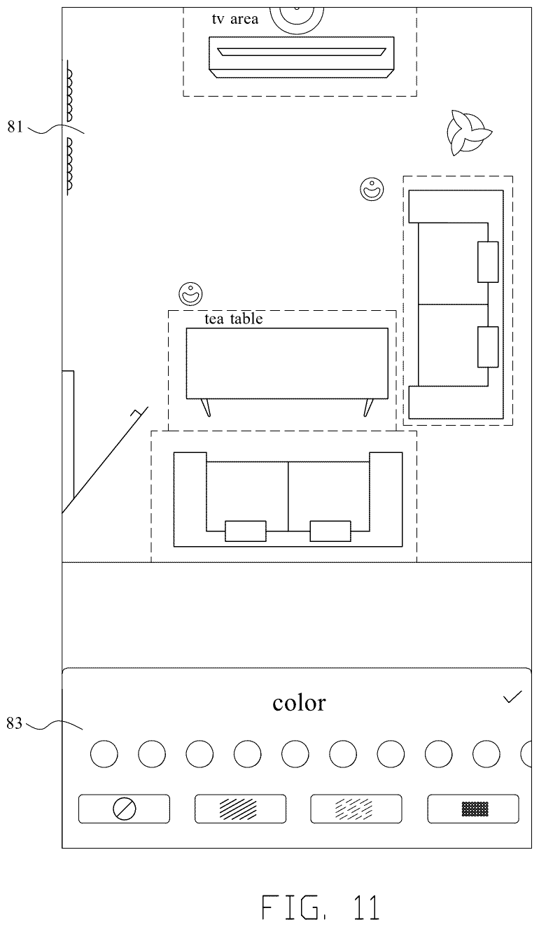

When the user selects the Color function item in FIG. 9, as shown in FIG. 11, the function configuration page 82 is covered by the attribute selection page 83 corresponding to Color. In the attribute selection page 83 corresponding to Color, color options and texture options are displayed. The computer device determines the corresponding color option and texture option as the color attribute information of the Color function item according to the user's selection. At the same time, the computer device changes the display effect of the custom region named “Monitoring Region 1” according to the color attribute information. For example, if the color attribute information indicates red+no texture, the background color are preset, and the user selects among the region attribute types displayed by the computer device. The computer device, in response to the region attribute type selected by the user, completes the configuration of the region attribute configuration item of the custom region.

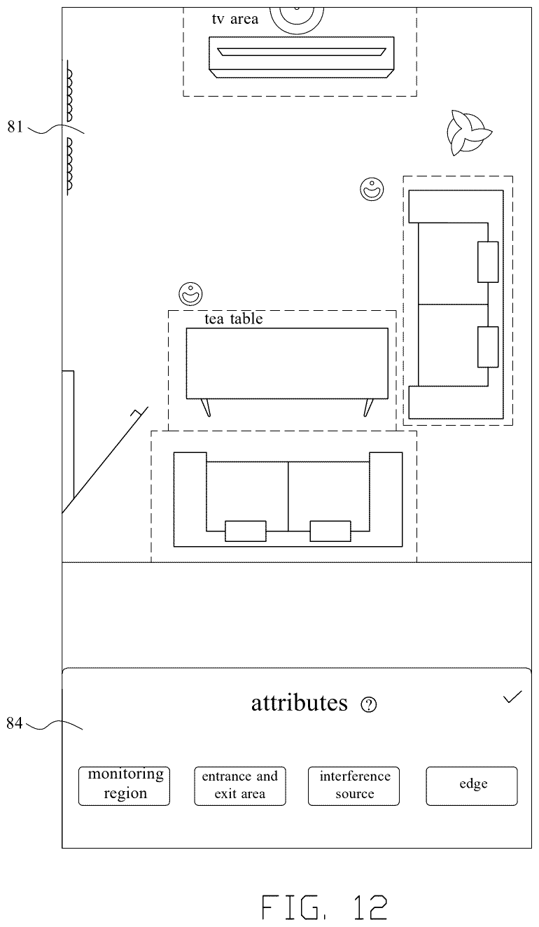

When the user selects the Attribute function item in FIG. 9, as shown in FIG. 12, the function configuration page 82 is covered by the region attribute selection page 84. In the region attribute selection page 84 there are displayed region attribute types. Specifically, the region attribute types include Monitoring Region, Entrance/Exit, Interference Source and Edge. The computer device determines the corresponding region attribute type as the region attribute information of “Monitoring Region 1” according to the user's selection. Then the computer device closes the region attribute selection page 84 and displays the function configuration page 82, and displays the determined region attribute information at the Attribute function item.

When the user selects the Type function item in FIG. 9, as shown in FIG. 10, the function configuration page 82 is covered by the type selection page. In the type selection page there are displayed type options. Specifically, the type options include Living Room, Dining Room, Study Room, Bedroom, Side Room and Others. The computer device determines the corresponding type option as the type attribute information of “Monitoring Region 1” according to the user's selection. Where, when the user selects Others, the computer device displays an editing page, and then configures the type attribute information input on the editing page as the type attribute information of “Monitoring Region 1”. Then the computer device closes the type selection page and displays the function configuration page 82, and displays the determined type attribute information at the Type function item, as specifically shown in FIG. 9.

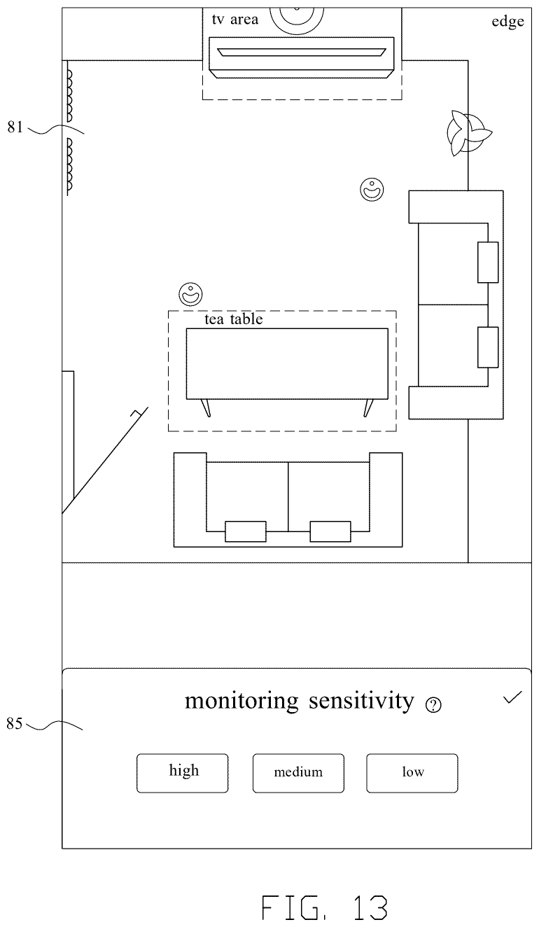

When the user selects the Monitoring Sensitivity function item in FIG. 9, as shown in FIG. 13, the function configuration page 82 is covered by the region monitoring selection page 85. In the region monitoring selection page 85 there are displayed region monitoring options. Specifically, the region monitoring options include High, Medium and Low. The computer device determines the corresponding region monitoring option as the region monitoring attribute of “Monitoring Region 1” according to the user's selection. Then the computer device closes the region monitoring selection page 85 and displays the function configuration page 82, and displays the determined region monitoring attribute at the Monitoring Sensitivity function item.

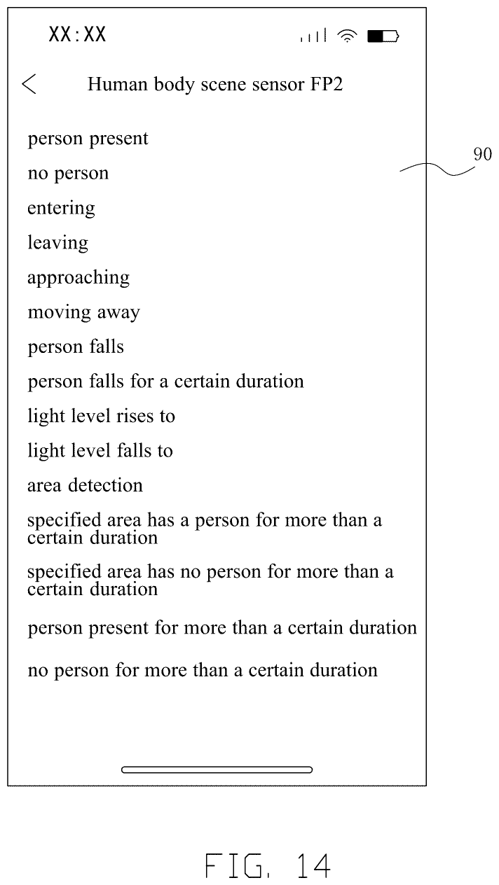

After the above operations are completed, an automation control scheme may be configured. As shown in FIG. 14, the computer device displays the trigger condition page 90 for the currently selected custom region. The trigger condition page 90 includes a plurality of automation control trigger conditions. By determining the automation control trigger condition, when the smart furniture is subsequently controlled, the smart furniture is controlled only when the automation control trigger condition is satisfied.

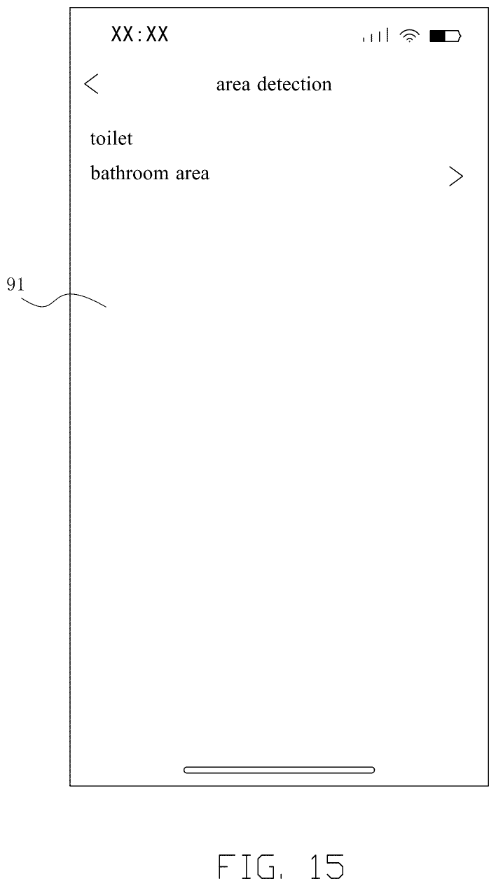

Specifically, the user may select automation control trigger conditions such as “person present” or “no person”, i.e., when a person is detected in the custom region the smart furniture is controlled, or when no person is detected in the custom region the smart furniture is controlled. The user may also select automation control trigger conditions such as “region detection” or “person present in designated region for more than a certain duration”. For example, as shown in FIG. 15, after “region detection” is selected the computer device displays the region option page 91. In the region option page 91 two options-“toilet” region and “bathroom area”—are displayed. At this moment the toilet option is selected, that is, the automation control trigger condition for the toilet region is configured; if the bathroom option is selected, the automation control trigger condition for the bathroom region is configured.

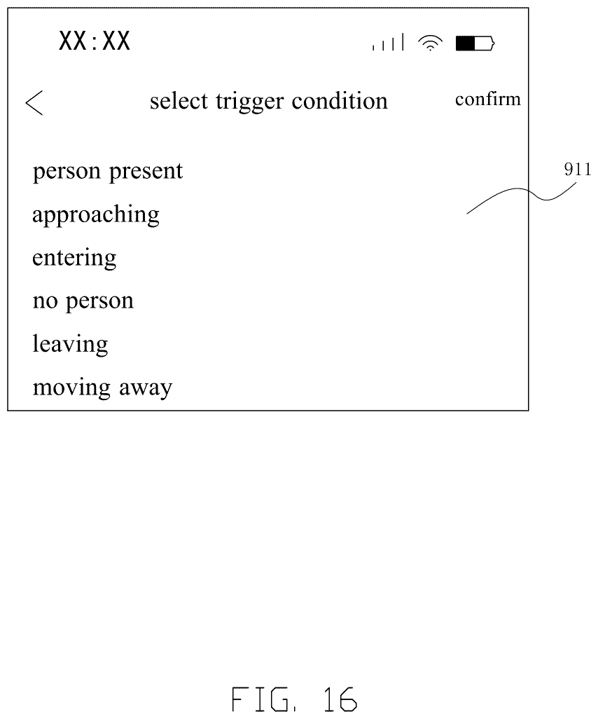

As shown in FIG. 16, after the user selects the toilet option the computer device displays the condition page 911. The condition page 911 contains the options person present, approaching, entering, no person, leaving and moving away. After the user selects one of the options, the selected option is taken as the automation control trigger condition for the designated or all smart furniture in the corresponding custom region.

By arbitrarily determining the custom region, the restriction on region configuration is removed, so that the user may configure each region more accurately, thereby achieving high accuracy region configuration. In addition, because the region management page corresponding to one room may be divided into a plurality of custom regions, one monitoring device may monitor a plurality of custom regions, reducing the number of hardware pieces and lowering the automation control cost of smart devices.

In addition, an application scenario is taken as an example for description.

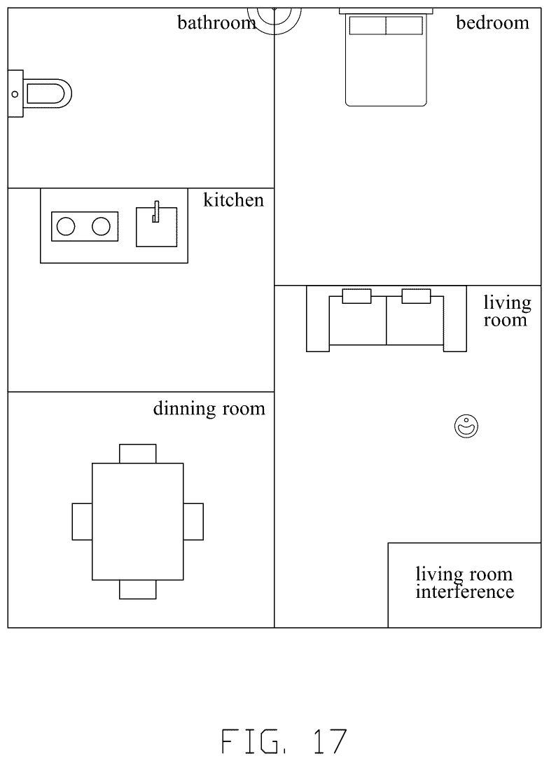

As shown in FIG. 17, the room includes five regions in total: bathroom, kitchen, dining room, bedroom and living room. When configuring the control of smart devices in the room, the smart phone displays the region management page. The region management page may be any one of the bathroom, kitchen, dining room, bedroom and living room. As shown in FIG. 9, the smart phone displays the living room in the region editing page 81.

The user touches the screen of the smart phone in the region editing page 81 to select any region, and the smart phone obtains the selected any region and generates a custom region, thereby achieving re division of the living room area. The user may slide with a single finger or tap to select grids in the region editing page 81, and the smart phone determines the coverage of the grids touched by the user as the custom region.

The smart phone displays, below the region editing page 81, the function configuration page of the generated custom region. In the function configuration page there are included the color configuration item, the type configuration item, the region attribute configuration item and the region monitoring attribute item.

After the user selects the color configuration item, the smart phone displays the color selection page below the region editing page. After the user selects the color and texture and taps the OK button in the upper right corner of the color selection page, the smart phone obtains the color attribute information, completes the color configuration for the custom region and displays the function configuration page containing the color configuration item whose configuration is completed.

After the user selects the type configuration item in the function configuration page, the smart phone obtains the trigger operation for the type configuration item and displays the type selection page below the region editing page. The user selects a type option in the type selection page or selects the edit option to edit the type attribute information. The smart phone completes the configuration of the type configuration item according to the selected type option or completes the configuration of the type configuration item according to the edited type attribute information, and simultaneously displays the function configuration page containing the type configuration item whose configuration is completed. The type options are, for example, dining area or sofa area, etc., and the edited type attribute information is, for example, TV area, fitness area and reading area, etc.

After the user selects the region attribute configuration item in the function configuration page, the smart phone obtains the trigger operation for the region attribute configuration item and displays the region attribute selection page below the region editing page. After the user selects a region attribute type in the region attribute selection page and taps the OK button in the upper right corner of the region attribute selection page, the smart phone obtains the region attribute information, configures the region attribute configuration item and displays the function configuration page containing the region attribute configuration item whose configuration is completed.

Specifically, the user may divide different custom regions according to the usage of the home space, and then determine the region attribute type of each custom region according to the usage. For example, for the sofa area, TV area and tea table area that need to be monitored, the region attribute type of the corresponding custom region is determined as the monitoring region so as to perform regional automation management. The smart phone may determine that the region attribute information of the custom region is entrance/exit and interference source through the recognition of doors and windows and the recognition of regions containing movable objects such as fans and curtains. In addition, the smart phone may determine that the region attribute information is edge area according to the strength of the target signal fed back by the sensor at the position where the signal is weak.

In addition, after the smart phone determines the region attribute information of each custom region, it automatically configures the region monitoring attribute of each custom region according to the region attribute information. For example, the region monitoring attributes of the interference area and the edge area are both set to low so as to reduce interference. When the interference area and the monitoring region overlap, the smart phone no longer automatically configures the region monitoring attribute of the corresponding custom region and pops up a region overlap prompt message to help prompt the user to adjust the range of the custom region or the type attribute information.

After the user selects the region monitoring attribute item in the function configuration page, the smart phone obtains the trigger operation for the region monitoring attribute item and displays the region monitoring selection page below the region editing page. After the user selects a region monitoring option and taps the OK button in the upper right corner of the region monitoring selection page, the smart phone obtains the region monitoring attribute, configures the region monitoring attribute item and displays the function configuration page containing the region monitoring attribute item whose configuration is completed.

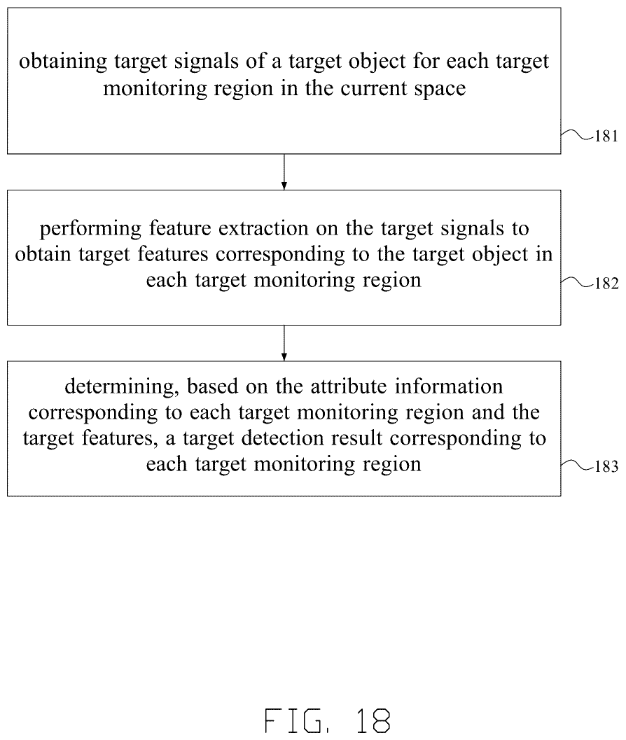

FIG. 18 is a flow schematic diagram of the target detection method in another embodiment. The present embodiment takes the method applied in a computer device as an example for description. It may be understood that the computer device may be a terminal device or a smart device having a target detection function, such as a radar device or other electronic device. The method may also be applied in a system including at least two of a smart device, a terminal device and a server, and is implemented through the interaction of at least two of a terminal device, a smart device, a gateway device and a server. As shown in FIG. 18, the target detection method in the present embodiment includes the following steps:
Step S181, obtaining target signals of a target object for each target monitoring region in the current space;
Step S182, performing feature extraction on the target signals to obtain target features corresponding to the target object in each target monitoring region;
Step S183, determining, based on the attribute information corresponding to each target monitoring region and the target features, a target detection result corresponding to each target monitoring region.

The target signals are signals collected by a signal collection device for the target object in each target monitoring region in the current space. Specifically, they may be, for example, echo signals received by a millimeter wave radar or image signals collected by an image collection device.

The target features are features of the target object and are used to determine the target detection result of the target object.

In one embodiment, Step S182—performing feature extraction on the target signals to obtain target features corresponding to the target object in each target monitoring region—may include comparing the echo signals to obtain feature point clouds of the target object in each target monitoring region, such as feature point clouds of a human body, feature point clouds of a pet dog, etc.

The attribute information includes a region monitoring attribute. The region monitoring attribute is obtained by configuring a user selection of an arbitrary area within the spatial region of the region management page to generate a target monitoring region and configuring, for each target monitoring region, a region monitoring attribute adapted to the spatial type of each target monitoring region. The confirmation process of the region monitoring attribute may refer to the related description of the first embodiment and will not be repeated here.

In one embodiment, Step S183: determining, based on the attribute information corresponding to each target monitoring region and the target features, a target detection result corresponding to each target monitoring region s, includes:
obtaining feature strength attributes corresponding to the target features of the target object in each target monitoring region;
determining, based on the region monitoring attribute of each target monitoring region and a feature strength attribute of each target feature, the target detection result corresponding to each target monitoring region.

In one embodiment, determining, based on the region monitoring attribute of each target monitoring region and a feature strength attribute of each target feature, the target detection result corresponding to each target monitoring region, includes:
when a region monitoring attribute of a current monitoring region is a low region monitoring attribute, and a corresponding feature strength attribute is a strong feature attribute, determining that the target detection result of the monitoring region is that a target is detected;
when the region monitoring attribute of the current monitoring region is a high region monitoring attribute, and the corresponding feature strength attribute is a weak feature attribute or a strong feature attribute, determining that the target detection result of the monitoring region is that the target is detected.

The low region monitoring attribute refers to a low monitoring attribute of the spatial region. When the computer device detects that the region monitoring attribute of the target monitoring region is low, if the feature strength attribute of the target monitoring region is greater than a first preset strength attribute, the computer device determines that the target detection result of the target monitoring region is that a target is detected. The high region monitoring attribute refers to a high monitoring attribute of the spatial region. When the region monitoring attribute of the target monitoring region is high and the feature strength attribute of the target monitoring region is greater than a second preset strength attribute, the computer device determines that the target detection result of the target monitoring region is that a target is detected. The first preset strength attribute is greater than the second preset strength attribute. Specifically, for example, the low region monitoring attribute may be low sensitivity, and the high region monitoring attribute may be high sensitivity.

In one embodiment, Step S183: determining a target detection result corresponding to each target monitoring region based on the region monitoring attribute of each target monitoring region and the feature strength attribute of each target feature, includes: when the region monitoring attribute of the current target monitoring region is a low region monitoring attribute and the corresponding feature strength attribute is a weak feature attribute, automatically discarding the feature strength attribute information so as to avoid false alarms.

Specifically, for example, if the current target monitoring region is a fitness area, the region monitoring attribute of the fitness area is a low region monitoring attribute, and the current feature strength attribute of the fitness area is a weak feature attribute such as a weak human body feature point cloud, the computer device automatically discards the information of the feature strength attribute. For example, in the target monitoring region having the low region monitoring attribute, the information of the weak human body feature point cloud is discarded and no human body detection report is made.

In one embodiment, the target object includes a human body; the region monitoring attribute includes region sensitivity. Step S183: determining, based on the region monitoring attribute corresponding to each target monitoring region and the target features, a target detection result corresponding to each target monitoring region, includes:
determining a human body detection result corresponding to each target monitoring region based on the region sensitivity of each target monitoring region and the feature strength attribute corresponding to the target features of the human body.

In one embodiment, after Step S183: determining, based on the region monitoring attribute corresponding to each target monitoring region and the target features, a target detection result corresponding to each target monitoring region, the method further includes: when the target detection result satisfies a trigger condition in a corresponding device control scheme, controlling a corresponding smart device to execute the device control scheme.

In one embodiment, the trigger condition is used to limit whether the computer device needs to control the smart device, for example, to control the smart device to start, pause, power off, etc. The trigger condition may be, for example, person present, no person, person present in designated region for more than a certain duration, no person in designated region for more than a certain duration, etc., and the present embodiment does not specifically limit this.

In one embodiment, the device control scheme is set according to a specific scenario, and the present embodiment does not specifically limit this. For ease of understanding, in an application scenario, the smart device is a toilet, and the device control scheme is: when a person is present in the custom region corresponding to the toilet, the toilet lid is opened; when the person leaves the toilet, flushing is performed. In another application scenario, the smart device is a TV, and the device control scheme is: when a person is present in the custom region corresponding to the sofa area, the TV is turned on; when the person has left the custom region corresponding to the sofa area for more than 3 minutes, the TV is turned off.

Specifically, when the human body detection result corresponding to the target monitoring region is that a human body is detected and the trigger condition of the automation control scheme of the target monitoring region is that a human body is detected, the corresponding device is controlled to execute the automation control scheme.

Specifically, the feature strength attribute corresponding to the target features of the human body may include a weak human body feature point cloud or a strong human body feature point cloud.

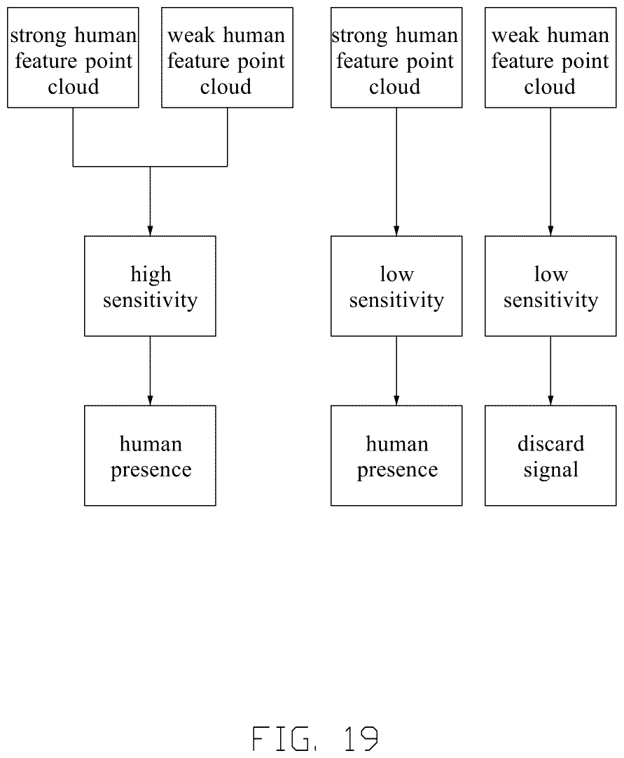

As shown in FIG. 19, when the region monitoring attribute of the current target monitoring region is a high region sensitivity (also called high sensitivity), no matter whether the corresponding feature strength attribute detected in the current target monitoring region is a weak human body feature point cloud or a strong human body feature point cloud, the computer device determines that the target detection result of the target monitoring region is that a human body is present.

When the region monitoring attribute of the current target monitoring region is a low region sensitivity (also called low sensitivity) and the corresponding feature strength attribute is a strong human body feature point cloud, the computer device determines that the target detection result of the target monitoring region is that a human body is present.

When the region monitoring attribute of the current target monitoring region is a low region sensitivity (also called low sensitivity) and the corresponding feature strength attribute is a weak human body feature point cloud, the computer device discards the signal.

In the target detection method of the present embodiment, the region monitoring attribute is obtained by configuring a user selection of an arbitrary area within the spatial region of the region management page to generate a target monitoring region and configuring, for each target monitoring region, a region monitoring attribute adapted to the spatial type of each target monitoring region. Target detection is performed for each target monitoring region according to the region monitoring attribute of each target monitoring region. Therefore, the accuracy of target detection may be improved.

The present disclosure further provides an application scenario, which may specifically be a smart home scenario. Specifically, the application of the region configuration method in the application scenario is as follows:
Taking human body detection for the living room as an example, the target detection method may include: the computer device preconfigures the mapping relationship between the TV area and the high sensitivity; pre divides the spatial region of the living room; displays the region management page including the spatial region corresponding to the living room; obtains any region selected in the spatial region to generate a custom selected monitoring region; in response to a selection operation on the monitoring region, displays the function configuration page for the selected monitoring region; obtains the TV area selected on the function configuration page and displays, on the function configuration page, the high sensitivity corresponding to the TV area; obtains the echo signal corresponding to the monitoring region of the TV area in the current living room; performs feature extraction on the echo signal to obtain the feature point cloud of the human body; and when the feature point cloud of the human body is a weak human body feature point cloud or a strong human body feature point cloud, determines that the target detection result of the monitoring region corresponding to the TV area is that a human body is present.

Specifically, the user may customize and set functional region blocks, namely monitoring regions, in the region management page through the computer device according to the distribution of the home space, and configure the corresponding region type for each functional region. Then the predetermined “region type-sensitivity matching” relationship is obtained, and the corresponding region sensitivity is automatically matched according to the region type of each functional region.

The “region type-sensitivity matching” relationship may be pre obtained by analyzing the point cloud data of different human bodies in different activity states. Specifically, the point cloud signal to noise ratio, speed and quantity strength of the human body in different activity states are analyzed. A moving human body has a large quantity of point clouds, high complexity, obvious speed and large signal to noise ratio; a static human body has a small quantity of point clouds, low speed, low signal to noise ratio and simple point clouds, and the “activity state vs. point cloud” correspondence is divided, for example, as shown in FIG. 5. Then the computer device may divide the approximate activity attribute of personnel in different living regions to obtain the “region vs. activity state” relationship; analyze the strength of environmental interference factors in different regions to establish the “region vs. interference source strength” relationship; and further judge the comprehensive influence ability of “point clouds” and “interference source strength” in different activity states on the sensitivity requirement of device identification.

Through the above steps, the following correspondences may be built in as matching factors: “activity vs. point cloud correspondence”, “region activity attribute+ region interference factor”, and “sensitivity correspondence”. Then through “region” mapping “region activity”, the required sensitivity is obtained through “region activity” (namely, point cloud complexity)+ “region interference source situation”, and further the relationship between different region types and device sensitivity is deduced, so that the matching relationship between region type and sensitivity is obtained as different. For example, the “fitness area” usually contains movements such as running, and the point clouds are complex; under weak interference, using medium sensitivity monitoring is more accurate. The correspondence between region type “label and sensitivity” is established.

Finally, in application, the user only needs to select the functional attribute of each functional region under his home space, namely the region type, through the computer device during the region configuration process. The background automatically matches the corresponding region sensitivity according to the “region type-sensitivity matching” relationship algorithm calculation rule, thereby improving region detection accuracy. At the same time, if the user considers that the default sensitivity does not match the actual usage, the user is also supported to reset a sensitivity for the region according to personal needs.

Through the above steps, the computer device may complete rapid setting of different regions. For a region with high sensitivity, the radar may still detect the human body well and feed back to the user end even when the human body is static. For example, the “bedroom area” defaults to “high sensitivity”, and even when asleep the radar may detect the human body and coordinate the smart system to execute corresponding sleep automation. For a region with low sensitivity, the radar reports a person only when the point clouds are sufficient to satisfy complex human body features, avoiding false alarms. For example, the “clothes drying area” defaults to “low sensitivity”, which may prevent the radar from falsely reporting the presence of a human body due to the shaking of drying clothes.

After the sensitivity configuration of each functional region is completed, the computer device detects the activity state of the target (e.g., human body) in each functional region based on the sensitivity configured for each region. The echo signal of the radar is obtained to determine the current point cloud data of the region, and the human body activity detection is reported in combination with the detection sensitivity algorithm rule already configured for the current region.

Specifically, the computer device may make a comprehensive judgment according to conditions created by the target (such as duration, point clouds, quality, moving distance, etc.), namely, according to the quantity of point clouds obtained, perform quality analysis in accordance with the condition rules corresponding to the sensitivity of each region, and further obtain the activity state of the target (e.g., human body) in each functional region.

For example, high sensitivity: low judgment duration, low point cloud quantity and quality requirement, low moving distance requirement. Low sensitivity: long judgment duration, high point cloud quantity and quality requirement, high moving distance requirement. Thereby, through different sensitivity settings, the human body activity state in different environmental regions is detected more accurately.

In the present embodiment, by setting the region type, the radar may perform different sensitivity detection for different regions. For a region with high sensitivity, the radar will report human body presence even for small point cloud fluctuations, ensuring that the radar may detect the human body and feed back to the user end even when the human body is in a sleep state. For a region with low sensitivity, the radar automatically discards point clouds whose human body feature recognition is not accurate enough, avoiding false alarms.

In one embodiment, the method further includes: when a state change of the target object in the target monitoring region is detected, triggering a calculation instruction.

In related technologies, after spatial regions are classified, the classified spatial regions are seldom applied, the utilization rate is low, and the application scenarios and functions of the classified spatial regions are singular. To solve the above problems, the embodiment of the present disclosure expands the application scenarios and functions of the classified spatial regions by performing device linkage between the target monitoring region and the target device, so that the management mode of region classification is diversified and the utilization rate of the classified spatial regions is improved.

In some embodiments, the device linkage application of the classified target monitoring region may be automatically triggered in advance in the target monitoring region, or may be triggered by a state change of the target object in the target monitoring region. Here, the trigger instruction for device linkage is not specifically limited. The state change of the target object in the target monitoring region may be a change in the quantity of target objects in the target monitoring region or a change in the position of the target object in the target monitoring region. Here, the state change of the target object is not specifically limited.

In one embodiment, the method further includes: obtaining current statistical data based on target position information; when the statistical data satisfies a preset condition, generating a corresponding linkage control instruction; and sending the linkage control instruction to a target device, so that the target device performs, based on the linkage control instruction, device linkage control.

Specifically, for example, the target monitoring region may be an entrance/exit region, and the state change of the target object in the target monitoring region may be a change in the quantity of target objects in the target monitoring region. When the sensing device monitors that a target person leaves within the monitoring range in the entrance/exit region, at this moment the sensing device triggers a calculation instruction for the quantity of target persons in the target monitoring region. In response to the calculation instruction, the quantity of target persons in the target monitoring region is counted through the sensing device, and statistical data indicating that target persons are present in the target monitoring region of the sensing device is determined.

The above statistical data is used to display state information of the spatial region corresponding to the target monitoring region. According to the state information, device linkage of the target monitoring region is performed with the target device. For the specific process of device linkage of the target monitoring region, please continue to refer to the following steps.

When the value of the statistical data of the target persons within the monitoring range of the sensing device satisfies a preset condition, a linkage control instruction corresponding to each step level in the preset condition may be generated. The preset condition may contain step levels used to represent different magnitudes of the statistical data of the target persons within the monitoring range. There is a correspondence between the step level of the preset condition and the linkage control instruction, and the correspondence between the step level of the preset condition and the linkage control instruction may be adjusted accordingly.

In one embodiment, generating the corresponding linkage control instruction includes:
when the statistical data is detected to be a first preset numerical value, generating a first linkage control instruction, the first linkage control instruction being an ON instruction;
when the statistical data is detected to be a second preset numerical value, generating a second linkage control instruction, the second linkage control instruction being an OFF instruction.

It should be noted that when the statistical data in the target monitoring region falls into different step levels of the preset condition, different linkage control instructions are generated. According to the different linkage control instructions, corresponding linkage control is performed on the target device. For example, when the target monitoring region is a living room area, the step level of the preset condition may be set to include two step levels of a first preset numerical value and a second preset numerical value. The first preset numerical value may be that the statistical data of target persons in the target monitoring region changes from zero to one, and the second preset numerical value may be that the statistical data of target persons in the target monitoring region changes from one to zero. Then, when the statistical data of the living room area is the first preset numerical value (from zero to one), a corresponding lighting device ON instruction is generated; when the statistical data of the living room area is the second preset numerical value (from one to zero), a corresponding lighting device OFF instruction is generated.

Specifically, in one embodiment, when it is detected that a target object enters the entrance/exit (target monitoring region), the counting of the number of persons in the spatial region within the monitoring range is triggered. When the number of persons in the spatial region within the monitoring range of the sensing device increases, it is judged whether the number of persons in the spatial region within the monitoring range changes from zero to one. If the number changes from zero to one, a light ON linkage is executed. When it is detected that a target object leaves the entrance/exit, the counting of the number of persons in the spatial region within the monitoring range is triggered. When the number of persons in the spatial region within the monitoring range of the sensing device decreases, it is judged whether the number of persons in the spatial region within the monitoring range changes from one to zero. If the number changes from one to zero, a light OFF linkage is executed.

Further, after the linkage control instruction corresponding to the statistical data in the target monitoring region is generated, the linkage control instruction is sent to the target device, and a corresponding control action is executed according to the linkage control instruction. Specifically, for example, the above lighting device ON instruction is sent to the lighting device already linked with the target monitoring region, and the lighting device ON action is executed; the above lighting device OFF instruction is sent to the lighting device already linked with the target monitoring region, and the lighting device OFF action is executed.

In this way, the technical solution of the present disclosure realizes the interaction between the user and the classified spatial region and/or the unclassified spatial region through at least one monitoring region in the region management page. On the premise of improving the accuracy and efficiency of spatial region classification, the classified spatial region is applied to a wider range of functions, the application scenario of spatial region classification is expanded, the application range of the classified spatial region is more diversified, and the utilization rate of the classified spatial region is improved.

In some related technologies in other fields, the manner of managing a spatial region is mostly to directly detect the quantity data of persons in the spatial region. This manner reduces the accuracy of the data collected in the current space, and when classifying different regions in the space according to the detection data, problems such as creating false targets and abnormal disappearance of targets occur. Therefore, in the subsequent steps of region classification according to the monitoring data, the accuracy is low.

To solve the above problems, the embodiment of the present disclosure collects position information when a target object is created and/or disappears in the monitoring range of the sensing device, and performs statistics on the position information when the target object is created and/or disappears to obtain target position information of the target object. It should be noted that the target position information obtained by performing statistics on the position information when the target object is created and/or disappears may be position information when the target object appears in the monitoring range and/or position information when the target object leaves the monitoring range.

The embodiment of the present disclosure performs statistics on dynamic position information of the target object in the monitoring range of the sensing device to obtain target position information of the target object (position information when the target object is created and/or disappears). By using the dynamic target position information to determine the target object, the problems of creating false targets and abnormal disappearance of targets are solved.

In some embodiments, before obtaining the target signals of the target object for each target monitoring region in the current space, the method further includes counting target position information when a state of the target object changes in the monitoring range of the sensing device. Specifically, the method includes:
collecting target signals within the monitoring range of a sensing device;
analyzing and processing the target signals to obtain first position information of the target object;
counting target position information when a state of the target object changes within the monitoring range of the sensing device.

In the present embodiment, by receiving the target signals reflected back in the monitoring range of the sensing device and analyzing the target signals, the first position information of the target object existing in the monitoring range of the sensing device is determined. The first position information may be position information when the target object is created or position information when the target object disappears. By counting the first position information when the target object is created or disappears, the target position information is obtained.

It should be noted that the first position information may be position information of the target object at a moment, and the target position information may be a plurality of position information when the target object changes position within a period of time. The target position information is a set of position information within the period of time when the target object changes position in the monitoring range of the sensing device. The above period of time may be the period of time from when the target object appears in the monitoring range of the sensing device to when it leaves. Correspondingly, the target position information may be position information when the target object is created and disappears in the monitoring range of the sensing device. It may be understood that, in other embodiments, the period of time (time period) when the target object changes position may be shortened. Correspondingly, the position information in the target position information corresponding to the target object collected in the monitoring range of the sensing device will be closer to each other, and vice versa.

The target position information may be a data set of coordinate information corresponding to the position change of the target object. For example, when the target position information corresponding to the target object contains position information when the target object is created and disappears in the monitoring range of the sensing device, the target position information may include coordinate information when the target object appears in the monitoring range and coordinate information when the target object leaves, or may be the distance of the target object from a preset reference object when the target object appears and leaves in the monitoring range. The position information of the target object is not specifically limited here.

Specifically, for example, in the present embodiment, the sensing device may be a millimeter wave radar sensor. The millimeter wave radar sensor emits microwave signals in every direction that the microwave signals of the millimeter wave radar sensor may reach, and analyzes the reflected millimeter wave radar signals to determine the target object existing in the monitoring range of the millimeter wave radar sensor and the position information of the detected target object. The position information of the target object may be coordinate information of the target object. Specifically, in the present embodiment, the frequency band and structure of the millimeter wave radar sensor are not specifically limited.

In the embodiment of the present disclosure, the position information may be coordinate information of the target object. The coordinate information represents the (X, Y) coordinates of the target object in the monitoring range of the sensing device. The target position information when the target object is created and/or disappears in the monitoring range of the sensing device may be coordinate data (X1, Y1) when the target object appears in the monitoring range and/or coordinate data (X2, Y2) when the target object leaves the monitoring range. After performing statistics on the coordinate data when a plurality of target objects appear and disappear, the statistical target position information of the target objects is obtained. The statistical target position information is a data set of coordinate data when a plurality of target objects appear and disappear.

In some embodiments, before obtaining the target signals of the target object for each target monitoring region in the current space, the method further includes:
generating cumulative values by counting target position information when a state of the target object changes;
when the cumulative value does not satisfy a preset target value, returning to count target position information when the state of the target object changes within the monitoring range of the sensing device, until the cumulative value satisfies the preset target value;
performing data analysis on counted target position information to obtain a first monitoring region satisfying a preset condition, wherein a quantity of target position information in the first monitoring region is greater than a preset threshold;
based on the first monitoring region, obtaining a target monitoring region.

It should be noted that, in the present disclosure, statistics on the target position information when the state of the target object changes in the monitoring range of the sensing device are performed to generate a cumulative numerical value of the target position information. When the cumulative numerical value reaches a preset target value, data analysis is performed on the target position information corresponding to the target object. The above scheme ensures the quantity of sample data of the statistical target position information, optimizes the data set for data analysis, improves the accuracy of the data for subsequent data analysis, and improves the accuracy of the classified region. Further, according to the above statistical target position information, data analysis is performed on the position information when the target object in the monitoring region is created and/or disappears, and target position information satisfying the data analysis preset condition is obtained. When the quantity of the target position information satisfying the data analysis preset condition is greater than a preset threshold, a corresponding monitoring region is generated according to the target position information satisfying the data analysis preset condition. The quantity of the target position information satisfying the data analysis preset condition and serving as the target position information constituting the monitoring region needs to be greater than the preset threshold so as to improve the accuracy of the monitoring region. The preset threshold is the minimum quantity of the target position information satisfying the data analysis preset condition.

In some embodiments, the step of performing the data analysis on the counted target position information to obtain the first monitoring region satisfying the preset condition includes:
clustering the target position information to obtain a clustering result after clustering analysis for the target position information, when the cumulative value satisfies a preset target value;
when a quantity of clusters in the clustering result exceeds a preset cluster threshold, retaining target position information corresponding to the clustering result whose quantity of clusters exceeds a preset cluster threshold;
determining the first monitoring region based on the target position information corresponding to the clustering result whose quantity of the clusters exceeds the preset cluster threshold.

It should be noted that the manner of performing data analysis on the statistical target position information may be performing clustering analysis on the data set of the statistical target position information. The clustering analysis is based on the density of sample points to determine all dense regions of the sample points, and takes all dense regions of the sample points as the clustering result of the clustering analysis.

For better understanding of the technical solution of the present disclosure, the clustering analysis of the present disclosure includes performing clustering analysis on N pieces of target position information. If the quantity of point clouds in a cluster is greater than T, the current region is calibrated as the first monitoring region; if the quantity of point clouds in the cluster is not greater than T, the statistical data of the target position information is cleared, and the counting of the target position information of the target object is returned.

In some embodiments, when the cumulative numerical value satisfies the preset target value, clustering the target position information to obtain a clustering result after clustering analysis of the target position information includes:
obtaining a position information set within a preset range for each target position information;
taking the position information set as the clustering result corresponding to each target position information.

When the cumulative numerical value satisfies the preset target value, clustering the target position information actually ensures the quantity of clustering results that may satisfy the clustering condition and improves the accuracy of the clustering result. The clustering result of the clustering analysis of the target position information may be the position information set within the preset range for each target position information. Specifically, the position information set within the preset range for each target position information may be a cluster corresponding to the coordinate data of the target position information.

Further, by judging whether there are clusters (information sets) whose quantity exceeds a preset threshold within the preset range of the coordinate data of the target coordinate information, namely whether the quantity of the clustering results within the preset range for each target position information exceeds the preset threshold, and if it exceeds, the monitoring region is determined according to the clusters corresponding to the coordinate data of the target position information whose quantity exceeds the preset threshold. The preset threshold may be adjusted accordingly. Correspondingly, when the monitoring range of the sensing device is large, the preset threshold is adjusted positively, the density of the target position information constituting the first monitoring region may be appropriately increased, and the accuracy of the first monitoring region is improved.

Specifically, the basic principle of performing clustering analysis on the statistical target position information is that the data set of the statistical target position information may contain coordinate data when a plurality of target objects are created and/or disappear, and each piece of coordinate data exists in the monitoring range of the sensing device in the form of a “point” of coordinate information. If within the range r of “point p” there are a certain quantity of other “points”, a cluster corresponding to “point p” is determined with “point p” as the core and r as the neighborhood, and a cluster corresponding to each “point” in the data set of the statistical target position information is generated. By judging the quantity of other “points” that are directly density reachable by the cluster corresponding to each “point”, if the quantity of directly density reachable points of the cluster corresponding to a certain point exceeds a threshold (the threshold may be adjusted appropriately), then by merging the clusters corresponding to each “point”, the first monitoring region is determined.

In some embodiments, the step of determining the first monitoring region based on the target position information corresponding to the clustering result whose quantity of clusters exceeds the preset clustering threshold, includes:
for a retained cluster, identifying core points and border points based on said sets of neighboring position information; and
generating said first monitoring region by defining a region that encompasses said core points and border points.

It should be noted that, according to the above quantity of clusters of the clustering result of the target coordinate information, the coordinate type of each target coordinate information is determined. The coordinate types include the core point, the boundary point and the noise point. The core point is located at the core position of the region corresponding to the clustering result, the boundary point is located at the boundary position of the region corresponding to the clustering result, and the noise point is a coordinate point whose quantity of clusters of the clustering result does not exceed the preset threshold. The noise point, as coordinate information with insufficient clustering density, may be directly discarded. The corresponding monitoring region is obtained by drawing according to the core point and the boundary point.

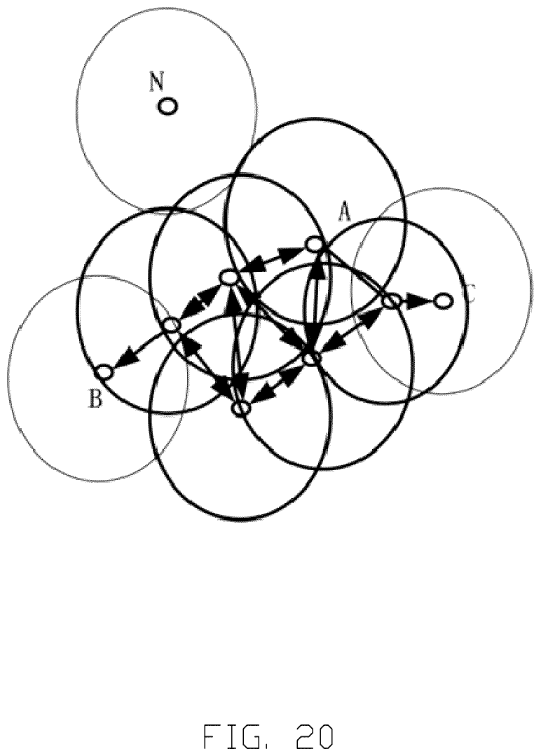

For better understanding of the technical solution of the present disclosure, reference may be made to FIG. 20, which is a specific schematic diagram of the clustering analysis of the present disclosure. The preset threshold MinPts of the quantity of clusters is set to 4. Through iteration it is found that point A satisfies the requirement of creating a core object p, and a cluster with A as the core is generated. Through continued iteration it is found that B and C also satisfy the requirement of creating a core object p, but B and C are located at the boundary of the entire cluster. Therefore, point A is a core point, B and C are boundary points. N does not satisfy the condition of being greater than or equal to the preset threshold MinPts of the quantity of clusters, and is taken as a noise point and may be discarded. In some embodiments, after the clustering is completed, B and C serve as boundary points and are connected to draw a rectangle, and the rectangle is taken as the monitoring region.

Specifically, for example, the sensing device monitors the spatial region within the monitoring range. When the cumulative quantity of the target position information in the spatial region within the monitoring range reaches 10, it indicates that the flow of persons in the region is relatively frequent. Clustering analysis is performed on the data set of the 10 pieces of target position information. The clustering analysis is used to determine the target position information that satisfies the preset condition in terms of the quantity of other target position information directly density reachable within the preset range. If after clustering, 5 pieces of target position information whose clustering density is greater than 4 are obtained, the 5 pieces of target position information are 5 points in the current spatial region. After the 5 pieces of target position information are classified, 1 is determined as a center point and 4 as boundary points. A rectangle is drawn by connecting the 4 boundary points, and the corresponding first monitoring region is obtained.

The monitoring region is obtained by performing drawing according to the core point and the boundary point obtained by performing clustering analysis on the target coordinate information of the target object in the monitoring range of the sensing device. If at least one monitoring region is included in the region management page, the monitoring region in the region management page may realize interaction with the user, and in a subsequent device linkage scheme, device linkage of different regions is realized through the classified monitoring region, thereby improving the user's interactive experience.

In one embodiment, a spatial configuration apparatus is provided, including: a first display module, a generation module, a second display module and a third display module.

The first display module is configured to display a region management page; the region management page including a spatial region corresponding to a target space. The generation module is configured to obtain a user selection of an arbitrary area within the spatial region and generate a custom region. The second display module is configured to, in response to a selection operation directed to the custom region, display a function configuration page for the custom region. The third display module is configured to, in response to a selection operation directed to the custom region, display a function configuration page for the selected custom region, wherein the function configuration page is configured to display configured attribute information adapted to the function item for the custom region; wherein the attribute information is configured for target detection within each custom regions.

In one embodiment, the function item includes a spatial type, the custom region includes a monitoring region selected for the spatial region, and the attribute information includes a region monitoring attribute. The function configuration page is configured to display the configured region monitoring attribute adapted to the spatial type for the monitoring region.

In one embodiment, the function configuration page includes a configuration item corresponding to the spatial type. The third display module includes: a first display unit, a second display unit and a third display unit. The first display unit is configured to, in response to a trigger operation for the configuration item corresponding to the spatial type, display a spatial type configuration page; the spatial type configuration page including a plurality of selectable spatial types. The second display unit is configured to, in response to a selected one of the plurality of selectable spatial types, display, on the function configuration page, the spatial type configured for the monitoring region. The third display unit is configured to display, on the function configuration page, an automatically configured region monitoring attribute adapted to the spatial type for the monitoring region.

In one embodiment, the third display module is configured to obtain a predetermined mapping relationship between spatial types and region monitoring attributes and, based on the predetermined mapping relationship, display, on the function configuration page, an automatically configured region monitoring attribute adapted to the spatial type for the monitoring region.

In one embodiment, the predetermined mapping relationship between spatial types and region monitoring attributes is obtained through relationship configuration. The third display module includes a relationship configuration unit. The relationship configuration unit is configured to obtain environmental signals corresponding to spatial regions of a plurality of spatial types, determine, based on the environmental signals, activity state features and interference features of a target object in each spatial region, and determine, based on a relationship between an activity state feature and an interference feature of the target object in each spatial region, mapping relationships between various spatial types and region monitoring attributes.

In one embodiment, the relationship configuration unit is further configured to: based on the mapping relationship between spatial types and region activity attributes and the mapping relationship between each region activity attribute and the activity state feature of the target object, determine the mapping relationship between various spatial types and the activity state features of the target object; based on the mapping relationship between various spatial types and the activity state features of the target object and the mapping relationship between each spatial type and the interference feature, determine the activity state features of the target object and the corresponding interference features corresponding to each spatial type; and, based on the mapping relationship between the activity state features and the interference features of each target object and the region monitoring attributes, determine the mapping relationship between various spatial types and the region monitoring attributes.

In one embodiment, the function configuration page includes a region monitoring attribute item. The spatial configuration apparatus further includes an adjustment module. The adjustment module is configured to, in response to a trigger operation on the region monitoring attribute item, display an attribute configuration page for the region monitoring attribute, and, in response to an adjustment operation on the configuration item corresponding to the region monitoring attribute on the attribute configuration page, display the adjusted region monitoring attribute under the region monitoring attribute item.

It should be noted that, when the spatial configuration apparatus provided in the above embodiment performs configuration, only the division of the above functional modules is taken as an example for illustration. In actual applications, the above functions may be allocated to be completed by different functional modules according to needs. That is, the internal structure of the spatial configuration apparatus is divided into different functional modules so as to complete all or part of the functions described above.

For specific limitations on the spatial configuration apparatus, reference may be made to the limitations on the region configuration method described above, which will not be repeated here. The modules in the above spatial configuration apparatus may be implemented wholly or partially by software, hardware or a combination thereof. The modules may be embedded in a processor in the form of hardware or independent of the processor in the computer device, or may be stored in a memory of the computer device in the form of software, so as to be called by the processor to execute operations corresponding to the modules.

In another embodiment, a target detection apparatus is provided, including a signal acquisition module, a feature acquisition module and a detection result determination module.

The signal acquisition module is configured to obtaining target signals of a target object for each target monitoring region in a current space. The feature acquisition module is configured to perform feature extraction on the target signals to obtain target features corresponding to the target object in each target monitoring region. The detection result determination module is configured to determine, based on the attribute information corresponding to each target monitoring region and the target features, a target detection result corresponding to each target monitoring region. The attribute information is obtained by configuring a user selection of an arbitrary area within a spatial region of the region management page, to generate a target monitoring region and configuring, for each target monitoring region, attribute information adapted to the function item within each target monitoring region.

In one embodiment, the detection result determination module includes: a strength attribute acquisition unit and a detection result determination unit. The strength attribute acquisition unit is configured to obtain feature strength attributes corresponding to the target features of the target object in each monitoring region. The detection result determination unit is configured to determine, based on the region monitoring attribute of each monitoring region and the feature strength attribute of each target feature, the target detection result corresponding to each monitoring region.

It should be noted that, when the target detection apparatus provided in the above embodiment performs detection, only the division of the above functional modules is taken as an example for illustration. In actual applications, the above functions may be allocated to be completed by different functional modules according to needs. That is, the internal structure of the target detection apparatus is divided into different functional modules so as to complete all or part of the functions described above.

For specific limitations on the target detection apparatus, reference may be made to the limitations on the target detection method described above, which will not be repeated here. The modules in the above target detection apparatus may be implemented wholly or partially by software, hardware or a combination thereof. The modules may be embedded in a processor in the form of hardware or independent of the processor in the computer device, or may be stored in a memory of the computer device in the form of software, so as to be called by the processor to execute operations corresponding to the modules.

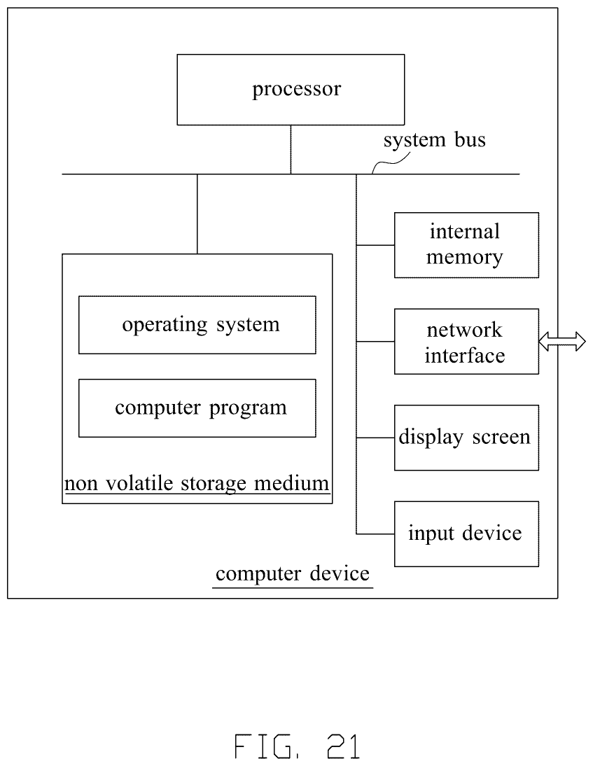

In one embodiment, a computer device is provided. The computer device may be a terminal or a server, and its internal structure diagram may be as shown in FIG. 21. The computer device includes a processor, a memory, a network interface, a display screen and an input device connected through a system bus. The processor of the computer device is configured to provide computing and control capabilities. The memory of the computer device includes a non volatile storage medium and an internal memory. The non volatile storage medium stores an operating system and a computer program. The internal memory provides an environment for the operation of the operating system and the computer program in the non volatile storage medium. The network interface of the computer device is configured to communicate with an external terminal through a network. When the computer program is executed by the processor, a region configuration method is implemented. The display screen of the computer device may be a liquid crystal display screen or an electronic ink display screen, and the input device of the computer device may be a touch layer covering the display screen, or may be keys, a trackball or a touch panel arranged on the housing of the computer device, or may be an external keyboard, touch panel or mouse, etc.

In one embodiment, a computer device is provided, including a memory and a processor. The memory stores a computer program, and when the computer program is executed by the processor, the steps in the above method embodiments are implemented.

In one embodiment, a computer readable storage medium is provided. A computer program is stored on the computer readable storage medium, and when the computer program is executed by a processor, the steps in the above method embodiments are implemented.

In one embodiment, a computer program product or computer program is provided. The computer program product or computer program includes computer instructions. The computer instructions are stored in a computer readable storage medium. A processor of a computer device reads the computer instructions from the computer readable storage medium, and the processor executes the computer instructions, so that the computer device executes the steps in the above method embodiments.

Those of ordinary skill in the art may understand that all or part of the processes in the methods of the above embodiments may be completed by instructing relevant hardware through a computer program. The computer program may be stored in a non volatile computer readable storage medium. When the computer program is executed, the steps of the embodiments of the above methods may be included. Among them, the memory, storage, database or other medium used in each embodiment of the present disclosure may include non volatile and/or volatile memory. The non volatile memory may include a read only memory (ROM), a programmable ROM (PROM), an electrically programmable ROM (EPROM), an electrically erasable programmable ROM (EEPROM) or flash memory. The volatile memory may include a random access memory (RAM) or an external high speed cache. By way of illustration and not limitation, RAM is available in many forms, such as static RAM (SRAM), dynamic RAM (DRAM), synchronous DRAM (SDRAM), double data rate SDRAM (DDR SDRAM), enhanced SDRAM (ESDRAM), synchronous link DRAM (SLDRAM), Rambus direct RAM (RDRAM), direct Rambus dynamic RAM (DRDRAM) and Rambus dynamic RAM (RDRAM), etc.

The technical features of the above embodiments may be arbitrarily combined. For concise description, not all possible combinations of the technical features in the above embodiments are described. However, as long as there is no contradiction between the combinations of the technical features, they should be considered as the scope described in this specification.

The above embodiments only express several embodiment manners of the present disclosure, and their description is specific and detailed, but they should not be therefore understood as limitations on the scope of the invention patent. It should be pointed out that for those of ordinary skill in the art, without departing from the concept of the present disclosure, several variations and improvements may be made, and these all fall within the protection scope of the present disclosure. Therefore, the protection scope of the patent of the present disclosure shall be subject to the appended claims.

What is claimed is:

1. A region configuration method, performed by a computer device, comprising:
displaying a region management page; the region management page comprising a spatial region corresponding to a target space;
obtaining a user selection of an arbitrary area within the spatial region, and generating a custom region;
in response to a selection operation directed to the custom region, displaying a function configuration page for the custom region;
obtaining a function item selected on the function configuration page, and displaying, on the function configuration page, configured attribute information adapted to the function item for the custom region; wherein the attribute information is configured for target detection within each custom region.

2. The method of claim 1, wherein the function item comprises a spatial type, the custom region comprises a monitoring region selected for the spatial region, and the attribute information comprises a region monitoring attribute;
wherein said obtaining the function item selected on the function configuration page, and displaying, on the function configuration page, the configured attribute information adapted to the function item for the custom region comprises:
obtaining the spatial type selected on the function configuration page, and displaying, on the function configuration page, the configured region monitoring attribute adapted to the spatial type within the monitoring region.

3. The method of claim 2, wherein the function configuration page comprises a configuration item corresponding to the spatial type;
wherein said obtaining the spatial type selected on the function configuration page, and displaying the configured region monitoring attribute adapted to the spatial type for the monitoring region comprises:
in response to a trigger operation for the configuration item corresponding to the spatial type, displaying a spatial type configuration page; the spatial type configuration page comprising a plurality of selectable spatial types;
in response to a selected one of the plurality of selectable spatial types, displaying, on the function configuration page, the spatial type configured for the monitoring region;
displaying, on the function configuration page, an automatically configured region monitoring attribute adapted to the spatial type for the monitoring region.

4. The method of claim 2, wherein displaying the configured region monitoring attribute adapted to the spatial type for the monitoring region, comprises:
obtaining a predetermined mapping relationship between spatial types and region monitoring attributes;
based on the predetermined mapping relationship, displaying, on the function configuration page, an automatically configured region monitoring attribute adapted to the spatial type for the monitoring region.

5. The method of claim 4, wherein the method obtains the predetermined mapping relationship between spatial types and region monitoring attributes through a relationship configuration step, and the relationship configuration step, comprises:
obtaining environmental signals corresponding to spatial regions of a plurality of spatial types;
determining, based on the environmental signals, activity state features and interference features of a target object in each spatial region;
determining, based on a relationship between an activity state feature and an interference feature of the target object in each spatial region, mapping relationships between various spatial types and region monitoring attributes.

6. The method of claim 1, wherein the custom region comprises a monitoring region;
wherein said obtaining a user selection of an arbitrary area within said spatial region to generate the custom region comprises:
displaying, on the region management page, at least one monitoring region set within a monitoring range of a sensing device in the target space;
in response to a trigger operation for setting a monitoring region on the region management page, marking a set monitoring region as a target monitoring region, and displaying, on the region management page, the target monitoring region.

7. The method of claim 6, wherein in response to the trigger operation for setting the monitoring region on the region management page, marking the set monitoring region as the target monitoring region, comprises:
in response to confirming the monitoring region within the monitoring range of the sensing device, triggering a push instruction;
in response to the push instruction, displaying a push window, wherein the push window is configured for displaying push information that the monitoring region is set as the target monitoring region;
in response to a trigger operation on a confirmation component in the push window, marking the monitoring region as the target monitoring region.

8. The method of claim 6, wherein said displaying on the region management page at least one monitoring region set within the monitoring range of the sensing device, comprises:
obtaining target position information of a target object within the monitoring range of the sensing device when a state of the target object changes;
performing data analysis on obtained target position information to obtain a first monitoring region satisfying a preset condition, wherein a quantity of target position information in the first monitoring region is greater than a preset threshold;
displaying, on the region management page, at least one first monitoring region.

9. The method of claim 1, wherein the region management page comprises a region editing page;
wherein said generating the custom region, comprises:
in response to a sliding operation on the region editing page, obtaining trajectory information corresponding to the sliding operation; generating a custom region associated with the sliding operation based on the trajectory information, and displaying, on the region editing page, the custom region;
generating the custom region corresponding to the sliding operation based on the trajectory information comprising at least one of the following:
determining a region mapped by the trajectory information, as the custom region corresponding to the sliding operation;
based on grid coordinate information corresponding to the trajectory information, determining a grid region traversed by the trajectory information, as the custom region corresponding to the sliding operation.

10. The method of claim 1, wherein said obtaining the function item selected on the function configuration page and displaying the configured attribute information adapted to the function item for the custom region, comprises:
in response to a trigger operation on a selected function item on the function configuration page, displaying an attribute selection page corresponding to the selected function item;
obtaining attribute information corresponding to a current function item selected on the attribute selection page, and configuring, based on the attribute information, a selected custom region for the current function item;
displaying, on the function configuration page, the configured attribute information.

11. The method of claim 10, wherein the function item comprises a type configuration item, and the attribute information comprises type attribute information;
wherein said obtaining the attribute information corresponding to the current function item selected on the attribute selection page, comprises at least one of the following:
in response to detecting a trigger operation on the type configuration item, displaying a type selection page corresponding to the type configuration item; the type selection page comprising a plurality of selectable type options; in response to a selection operation on a type option in the type selection page, configuring a selected type option as the type attribute information for the custom region; and
in response to a trigger operation on an editing entry in the type selection page, displaying an editing page; and configuring type attribute information input on the editing page as the type attribute information for the custom region.

12. The method of claim 10, wherein the function item comprises a region attribute configuration item and a region monitoring attribute item, and the attribute information comprises region attribute information and a region monitoring attribute;
wherein said obtaining the attribute information corresponding to the current function item selected on the attribute selection page, and configuring, based on the attribute information, a selected custom region for the current function item, comprises:
in response to detecting a trigger operation on the region attribute configuration item, displaying a region attribute selection page corresponding to the region attribute configuration item; the region attribute selection page comprising a plurality of selectable region attribute types;
obtaining a region attribute type selected on the region attribute selection page, and configuring the region attribute type as the region attribute information for the custom region; and
displaying, on a page corresponding to the region monitoring attribute item, a configured region monitoring attribute adapted to the region attribute type for the custom region; wherein the region monitoring attribute is configured for target detection within each custom region according to the region monitoring attribute within each monitoring region.

13. The method of claim 12, further comprising, after said step of configuring:
in response to detecting a trigger operation on the region monitoring attribute item, displaying a region monitoring selection page corresponding to the region monitoring attribute item; wherein the region monitoring selection page comprises a plurality of selectable region monitoring options;
in response to a selection operation on a region monitoring option in the region monitoring selection page, configuring a selected region monitoring option as a region monitoring attribute for the custom region.

14. A target detection method, performed by a computer device, comprising:
obtaining target signals of a target object for each target monitoring region in a current space;
performing feature extraction on the target signals to obtain target features corresponding to the target object in each target monitoring region;
determining, based on attribute information corresponding to each target monitoring region and the target features, a target detection result corresponding to each target monitoring region; wherein the attribute information is obtained by configuring a user selection of an arbitrary area within a spatial region of a region management page, to generate target monitoring regions, and for each target monitoring region, configuring attribute information adapted to function items for each target monitoring region.

15. The target detection method of claim 14, wherein the attribute information comprises a region monitoring attribute; wherein said determining the target detection result based on said attribute information and said target features comprises:
obtaining feature strength attributes corresponding to the target features of the target object in each target monitoring region;
determining, based on the region monitoring attribute of each target monitoring region and a feature strength attribute of each target feature, the target detection result corresponding to each target monitoring region;
wherein said determining comprises at least the following:
when a region monitoring attribute of a current monitoring region is a low region monitoring attribute, and a corresponding feature strength attribute is a strong feature attribute, determining that the target detection result of the monitoring region is that a target is detected;
when the region monitoring attribute of the current monitoring region is a high region monitoring attribute, and the corresponding feature strength attribute is a weak feature attribute or a strong feature attribute, determining that the target detection result of the monitoring region is that the target is detected.

16. The target detection method of claim 14, further comprising, after said step of determining:
when the target detection result satisfies a trigger condition in a corresponding device control scheme, controlling a corresponding smart device to perform the device control scheme.

17. The target detection method of claim 14, wherein the method further comprises:
obtaining current statistical data based on target position information;
when the current statistical data satisfies a preset condition, generating a corresponding linkage control instruction;
sending the linkage control instruction to a target device, so that the target device performs, based on the linkage control instruction, device linkage control.

18. The target detection method of claim 14, wherein before obtaining the target signals of the target object for each target monitoring region in the current space, the method comprises:
collecting target signals within a monitoring range of a sensing device;
analyzing and processing the target signals to obtain first position information of the target object;
counting target position information when a state of the target object changes within the monitoring range of the sensing device;
generating cumulative values by counting target position information when a state of the target object changes;
when the cumulative value does not satisfy a preset target value, returning to count target position information when the state of the target object changes within the monitoring range of the sensing device, until the cumulative value satisfies the preset target value;
performing data analysis on counted target position information to obtain a first monitoring region satisfying a preset condition, wherein a quantity of target position information in the first monitoring region is greater than a preset threshold;
obtaining the target monitoring region based on the first monitoring region.

19. The target detection method of claim 18, wherein said performing the data analysis on the counted target position information to obtain the first monitoring region satisfying the preset condition, comprises:
clustering the target position information to obtain a clustering result after clustering analysis for the target position information, when the cumulative value satisfies a preset target value;
when a quantity of clusters in the clustering result exceeds a preset cluster threshold, retaining target position information corresponding to the clustering result whose quantity of clusters exceeds a preset cluster threshold;
determining the first monitoring region based on the target position information corresponding to the clustering result whose quantity of the clusters exceeds the preset cluster threshold;
said clustering the target position information to obtain the clustering result after clustering analysis for the target position information, when the cumulative value satisfies the preset target value comprising: obtaining a position information set within a preset range for each target position information; acting the position information set as the clustering result corresponding to each target position information;
wherein said determining said first monitoring region comprises:
for a retained cluster, identifying core points and border points based on said sets of neighboring position information; and
generating said first monitoring region by defining a region that encompasses said core points and border points.

20. A computer device, comprising a memory and a processor, wherein the memory stores instructions which, when executed by the processor, cause the processor to carry out the method according to claim 1.
